(19) United States
(12) Patent Application Publication
(10) Pub. No.: US 2012/0290379 A1
(43) Pub. Date: Nov. 15, 2012

(54) System and method for facilitating the onboarding of prospective payers to an electronic payment system.

(75) Inventors: Amy Beth Hoke, Gilford, NH (US); Christopher Curtis Martin, Portsmouth, NH (US)

(73) Assignee: Bottomline Technologies (DE) Inc., Portsmouth, NH (US)

(21) Appl. No.: 13/374,071

(22) Filed: Dec. 9, 2011

Related U.S. Application Data
(63) Continuation-in-part of application No. 13/068,558, filed on May 13, 2011.
Application No. 13/068,558 is a continuation-in-part of application No. 13/136,581, now abandoned.
Application No. 13/136,581 is a continuation-in-part of application No. 13/200,581, filed on Sep. 26, 2011.

(51) Int. Cl. G06Q 30/02

(52) U.S. Cl. 705/14.25

(57) ABSTRACT

A system for marketing, to a prospective payer, a system which automates payments to enrolled vendors. The system comprises a vendor history file received from the prospective payer which associates identifying attributes and annual spend value with each target vendor to which the payer makes payments. Marketing instructions include, for each target vendor, determining a rebate potential by: i) using the identifying attributes to determine a industry code to associate with the target vendor; ii) using the industry code to look up a sensitivity rating; iii) calculating a transaction fee rate as a function of the sensitivity rating; and iv) calculating rebate potential as the product of the spend value multiplied by the transaction fee rate. An onboard report includes identification of the prospective payer and in association with the identification of the prospective payer, the rebate potential.

### TECHNICAL FIELD

The present invention relates to electronic payment and remittance systems, and more particularly, to a system which interacts with an electronic payment and remittance system to facilitate the marketing and on-boarding of prospective payers to the electronic payment and remittance system.

### BACKGROUND OF THE INVENTION

Electronic payments are becoming more common place for settling both consumer and business to business transactions. The most common electronic payment mechanism in the consumer world is a payment card such as a credit card, charge card, or debit card. Generally, payment cards are issued by an operator of a card payment system such as American Express or Diners Club (sometimes called a closed loop system), or by a bank or financial institution under licensing from a bank card brand provider such as Visa or Mastercard (formerly bank card associations).

In a card payment system, the financial institution issuing the card handles authorizations and all aspects of the transaction and settles payment with the merchant/vendor and the consumer/cardholder. More specifically, when a consumer pays for a purchase using a credit card issued as part of a card payment system, the merchant/vendor's point of sale terminal is used to obtain, from the issuer, an authorization for the payment amount. The authorization represents a guarantee that the issuer will pay the authorized amount. Once authorization is obtained the merchant/vendor can provide the goods or services without concern as to whether the consumer will pay for the goods or services because consumer credit risk is on the issuer that provided the authorization (guarantee of payment), not the merchant/vendor that obtained the authorization (guarantee of payment). To settle the transaction, the issuer pays the merchant/vendor the authorized amount less a transaction fee. The transaction fee is established by contract between the merchant/vendor and the card payment system operator/issuer at the time the merchant/vendor opens its merchant account with the close loop system operator/issuer.

When a bank or financial institution issues a payment card under licensing from a bank card brand provider such as Visa or Mastercard, the bank is referred to as the Issuing Bank. To accept payment by payment card issued under license from a bank card brand provider, a merchant/vendor opens a merchant account with a bank of financial institution that is also licensed by the bank card brand provider. The bank at which the merchant/vendor has its merchant account is called the Acquiring Bank. The Issuing Bank and the Acquiring Bank may be different banks.

When a consumer pays for a purchase using a payment card licensed under a bank card brand provider, the vendor's point of sale terminal is used to access the brand provider's settlement network and obtain an authorization for the payment amount. The authorization represents a guarantee that the Issuing Bank will fund the authorized amount. Once authorization is obtained, the transaction is processed. More specifically, the Acquiring Bank funds the vendor's Merchant Account with the amount of the transaction less a transaction fee that is established by contract between the Acquiring Bank and the merchant/vendor. The Acquiring Bank obtains payment from the Issuing Bank through the brand provider's settlement network and pays a fee, called an interchange fee, to the brand provider. The brand provider keeps a portion of the interchange fee and credits a portion of the interchange fee back to the Issuing Bank.

The issuer in the card payment model and the Issuing Bank in the bank brand provider model may use a portion of the transaction fee (or the Issuing Bank's portion of the interchange fee) to fund a reward program that provides some financial benefit to the cardholder or, in the case of a commercial card program, rewards back to the company. Examples of reward programs include airline mileage reward programs and cash back rebate programs (for example 1% cash back). The terms and conditions of the reward program, and the financial benefit provided to the cardholder under the reward program, is controlled by the issuer/Issuing Bank.

Further, the issuer in the card payment model and the Issuing Bank in the bank brand provider model may charge the cardholder for use of the card. Such a charge is typically in the form of an annual fee. The amount of any charge to the cardholder is determined by the issuer/Issuing Bank.

It should be appreciated that the cardholder (i.e. the payer) making payment to the merchant/vendor does not determine the transaction fee paid by the vendor. The transaction fee paid by the vendor is determined by the issuer in the card payment model and the Acquiring Bank in the brand provider model.

In the consumer market, card payment has grown dramatically since the first card payment systems were introduced in the late 1940s and 1950s (Diners Club in 1949, American Express in 1959) and the first association branded cards were introduced in 1966 (BankAmericard, which is now VISA, and InterBank Card, which is now MasterCard, both card brand providers). One of the primary drivers of growth has been that merchant/vendors are willing to accept card payments and pay the corresponding transaction fee to eliminate credit risk of the individual consumer purchasing from the merchant/vendor. Once a transaction is authorized, payment to the merchant/vendor is guaranteed.

Recently, card issuers, in particular the bank card brand providers and their participating banks, have been marketing card payments for business to business transactions. In general, an Issuing Bank issues a purchase card to a business and the business uses the card to pay vendors. Vendors must have a Merchant Account with an Acquiring bank and pay the applicable fees as determined by the Acquiring Bank. The Acquiring bank pays an interchange fee on the transaction, at least part of which is paid to the Issuing Bank. Currently purchasing card payments represent less than 4% of the business to business payments in the United States. It is speculated that purchasing card payments are not being adopted for business to business transactions as rapidly as adoption for consumer transactions for at least two reasons. First, most business to business payments are payments in the ordinary course of an ongoing relationship between the vendor and the payer and the vendor sees little credit risk in being paid. As such, the vendor sees little advantage of receiving a guarantee of payment at authorization, and while many vendors may be willing to pay a small transaction fee for the convenience of immediate payments, the guarantee of immediate payment is not enough to justify payment of the high fixed transaction fee charged by the Acquiring Bank. Second, purchase card payments are difficult for both the payer and the vendor to reconcile in their respective accounts payable and accounts receivable accounting systems without at least duplicating manual entry of at least some payment/remittance information in multiple systems.

Even though there has been little adoption of purchase cards and card payments for business to business transactions, business to business payers still seek electronic payment solutions to lower costs associated with traditional check payments, and possible generate revenue from, their accounts payable.

In view of the foregoing, what is needed is a system and method for facilitating the marketing of electronic payment and remittance systems to businesses which are prospective payers and have potential for lowering costs associated with check payments and generating revenue from accounts payable.

### SUMMARY OF THE INVENTION

A first aspect of the present invention comprises a system for marketing, to a prospective payer, an electronic payment and remittance system which automates payments from each enrolled payer, of a community of payers, to each enrolled vendor, of a community of vendors.

The system comprises a computer readable medium, non transitory data structures encoded on the computer readable medium, computer code encoded on the computer readable medium, and a processor executing the computer code.

A first of the non-transitory data structures comprises a vendor history file received from the prospective payer. The vendor history file comprises a group of unique records. Each unique record associates with a unique target vendor of a group of target vendors to which the prospective payer makes payment, and identifies: i) attributes of the target vendor; and ii) a target vendor spend value. The target vendor spend value is the amount paid, or payable, by the prospective payer to the target vendor over a predetermined period of time such as one year.

A second of the non-transitory data structures comprises a sensitivity score database. The sensitivity score database associates each industry code of a group of industry codes with a sensitivity rating.

Computer instructions coded to the computer readable media and executed by the processor comprise prospective payer marketing instructions, such instructions include, for each target vendor of a first group of target vendors, determining a target vendor industry based rebate potential by: i) using the identifying attributes to determine an industry code to associate with the target vendor, the industry code being a selected one of the group of industry codes which identifies an industry in which the target vendor participates; ii) looking up, in the sensitivity score database, the sensitivity rating associated with the industry code associated with the target vendor; iii) calculating a target transaction fee rate as a function of the sensitivity rating associated with the industry code; and iv) calculating the target vendor industry based rebate potential, the target vendor industry based rebate potential being the product of the target vendor spend value multiplied by the target transaction fee rate.

Such instructions further comprise: i) calculating an industry based rebate potential, the industry based rebate potential being the sum of each target vendor industry based rebate potential calculated for each target vendor of the group of the first group of target vendors; and ii) generating an onboard report. The onboard report may be a non transitory data structure stored on the computer readable medium, the on board report including identification of the prospective payer and, in association with the identification of the prospective payer, the industry based rebate potential.

In one sub-aspect, the non transitory data structures may further comprise a vendor community database. The vendor community database comprising a group of unique records. Each unique record associates with a unique enrolled vendor of the community of vendors and identifies: i) attributes of the enrolled vendor; and ii) a first enrolled payer transaction fee rate applied to payments to the enrolled vendor by at least a first enrolled payer.

The instructions of the payer marketing application further comprise, for each target vendor: i) determining that the target vendor is an enrolled target vendor if identifying attributes of the target vendor from the record of the vendor history file match identifying attributes of an enrolled vendor from a record of the vendor community database; ii) determining that the target vendor is a non-enrolled target vendor if identifying attributes of the target vendor from the record of the vendor history file do not match identifying attributes of an enrolled vendor from a record of the vendor community database.

In this sub aspect, the group of target vendors is a first group of target vendors consist only of non-enrolled target vendors.

Such instructions further comprise, for each target vendor of a second group of target vendors consisting of enrolled target vendors: i) determining a target vendor enrollment based rebate potential, the target vendor enrollment based potential being the product of the target vendor spend value multiplied by the a target transaction fee rate, the target transaction fee rate being a function of the first enrolled payer transaction fee rate associated with the target vendor; and ii) calculating an enrolled vendor rebate potential. The enrolled vendor rebate potential may be the sum of the target vendor enrollment based rebate potential determined for each enrolled target vendor.

The onboarding report may further comprise identification of the enrolled vendor rebate potential.

In a further sub aspect, for each enrolled vendor of a subset of the community of enrolled vendors that are paid by more one enrolled payer, the record of the vendor community database associated with the enrolled vendor further includes: i) a first enrolled payer spend value, the first enrolled payer spend value representing the amount payable by the first enrolled payer to the enrolled vendor during the period of time; ii) a second enrolled payer transaction fee rate applied to payments to the enrolled vendor by at least a second enrolled payer, the second enrolled payer transaction fee rate being different than the first enrolled payer transaction fee rate; and iii) a second enrolled payer spend value, the second enrolled payer spend value representing the amount payable by the second enrolled payer to the enrolled vendor during the period of time.

In this sub aspect, determining the target transaction fee rate comprises: i) selecting the first enrolled payer transaction fee rate as the target transaction fee rate if the amount payable by the prospective payer to the enrolled vendor over the period of time is closer to the first enrolled payer spend value than to the second enrolled payer spend value; and ii) selecting the second enrolled payer transaction fee rate as the target transaction fee rate if the amount payable by the prospective payer to the enrolled vendor over the period of time is closer to the second enrolled payer spend value than to the first enrolled payer spend value.

In another sub aspect, the vendor history file further includes, for each target vendor, identification of the quantity of payments made by the prospective payer to the target vendor during the period of time.

In this sub aspect, for each enrolled vendor of a subset of the community of vendors that are paid by more one enrolled payer, the record of the vendor community database associated with the enrolled vendor further includes: i) a first enrolled payer spend frequency, the first enrolled payer spend frequency representing the quantity of payments made by the first enrolled payer to the enrolled vendor during the period of time; ii) a second enrolled payer transaction fee rate applied to payments to the enrolled vendor by at least a second enrolled payer, the second enrolled payer transaction fee rate being different than the first enrolled payer transaction fee rate; and iii) a second enrolled payer spend frequency, the second enrolled payer spend frequency representing the amount payable by the second enrolled payer to the enrolled vendor during the period of time.

In this sub aspect, determining the target transaction fee rate comprises: i) selecting the first enrolled payer transaction fee rate as the target transaction fee rate if the quantity of payments made by the prospective payer to the target vendor during the period of time is closer to the first payer enrolled payer spend frequency than to the second enrolled payer spend frequency; and ii) selecting the second enrolled payer transaction fee rate as the target transaction fee rate if the quantity of payments made by the prospective payer to the target vendor during the period of time is closer to the second enrolled payer spend frequency than to the first enrolled payer spend frequency.

In yet another sub aspect, the vendor history file further includes, for each target vendor, identification of the quantity of payments made by the prospective payer to the enrolled vendor during the period of time.

In this sub aspect, for each enrolled vendor of a subset of the community of vendors that are paid by more one enrolled payer, the record of the vendor community database associated with the enrolled vendor further includes: i) a first enrolled payer spend value, the first enrolled payer spend value representing the amount payable by the first enrolled payer to the enrolled vendor during the period of time; ii) a first enrolled payer spend frequency, the first enrolled payer spend frequency representing the quantity of payments made by the first enrolled payer to the enrolled vendor during the period of time; iii) a second enrolled payer transaction fee rate applied to payments to the enrolled vendor by at least a second enrolled payer, the second enrolled payer transaction fee rate being different than the first enrolled transaction fee rate; iv) a second enrolled payer spend value, the second enrolled payer spend value representing the amount payable by the second enrolled payer to the enrolled vendor during the period of time; and v) a second enrolled payer spend frequency, the second enrolled payer spend frequency representing the quantity of payments made by the second enrolled payer to the enrolled vendor during the period of time.

In this sub aspect determining the target transaction fee rate comprises: i) calculating a first enrolled payer spend volume differential value, the first enrolled payer spend volume differential value being a function of the difference between the first enrolled payer spend value and amount payable by the prospective payer to the enrolled vendor over the period of time; ii) calculating a second enrolled payer spend volume differential value, the second enrolled payer spend volume differential value being a function of the difference between the second enrolled payer spend value and amount payable by the prospective payer to the enrolled vendor over the period of time; iii) calculating a first enrolled payer spend frequency differential value, the first enrolled payer spend frequency differential value being a function of the difference between the first enrolled payer spend frequency and the quantity of payments made by the prospective payer to the enrolled vendor over the period of time; iv) calculating a second enrolled payer spend frequency differential value, the second enrolled payer spend frequency differential value being a function of the difference between the second enrolled payer spend frequency and the quantity of payments made by the prospective payer to the enrolled vendor over the period of time; v) calculating a first enrolled payer weighted average, the first enrolled payer weighted average being the average of: a) the first enrolled payer spend volume differential value multiplied by a first coefficient; and b) the first payer spend frequency differential value multiplied by a second coefficient; vi) calculating a second enrolled payer weighted average, the second enrolled payer weighted average being the average of: a) the second enrolled payer spend volume differential value multiplied by the first coefficient; and b) the second enrolled payer spend frequency differential value multiplied by the second coefficient; vi) selecting the first enrolled payer transaction fee rate as the target transaction fee rate if the first enrolled payer weighted average is less than the second enrolled payer weighted average; and vii) selecting the second enrolled payer transaction fee rate as the target transaction fee rate if the second enrolled payer weighted average is less than the first enrolled payer weighted average.

A second aspect of the present invention comprises a system for marketing, to a prospective payer, an electronic payment and remittance system which automates payments from each enrolled payer, of a community of payers, to each enrolled vendor, of a community of vendors.

The system comprises a computer readable medium, non transitory data structures encoded on the computer readable medium, computer code encoded on the computer readable medium, and a processor executing the computer code.

A first data structure comprises a vendor community database. The vendor community database comprises a group of unique records. Each record associates a unique enrolled vendor of the community of vendors, identifying attributes of the unique enrolled vendor, and a first enrolled payer transaction fee rate applied to payments to the enrolled vendor by at least a first enrolled payer.

A second data structure comprises a vendor history file received from the prospective payer. The vendor history file comprises a group of unique records. Each unique record associates with a unique target vendor of a group of target vendors to which the prospective payer makes payment, identifying attributes of the target vendor and a target vendor spend value. The target vendor spend value may be the amount paid or payable by the prospective payer to the target vendor over a predetermined period of time such as one year.

The computer instructions coded to the computer readable media and executed by the processor comprise payer marketing instructions, such instructions comprising, for each target vendor: i) determining that the target vendor is an enrolled target vendor if identifying attributes of the target vendor from the record of the vendor history file match identifying attributes of an enrolled vendor from a record of the vendor community database; ii) for each enrolled target vendor, determining a target vendor enrollment based rebate potential, the target vendor enrollment based rebate potential being the product of the target vendor spend value multiplied by the a target transaction fee rate, the target transaction fee rate being a function of the first enrolled payer transaction fee rate associated with the target vendor; iii) calculating an enrolled vendor rebate potential, the enrolled vendor potential being the sum of the target vendor enrollment based rebate potential determined for each target vendor that is an enrolled vendor; and iv) generating an onboard report, the onboard report being a non transitory data structure stored on the computer readable medium, the on board report including identification of the prospective payer and, in association with the identification of the prospective payer, the total quantity of target vendors which are enrolled target vendors, and the enrolled vendor rebate potential.

In a first sub aspect: i) the payer marketing instructions may further comprise calculating enrolled vendor spend value, enrolled vendor spend value being the sum of the target vendor spend values associated with each target vendor which is determined to be an enrolled vendor; and ii) the onboard report further includes, in association with identification of the prospective payer, the enrolled vendor spend value.

Further in this sub aspect, the instructions of the payer marketing application further comprise: i) determining that the target vendor is a non-enrolled vendor if identifying attributes of the target vendor from the record of the vendor history file do not match identifying attributes of an enrolled vendor from a record of the community database; and ii) for each non-enrolled target vendor, determining a target vendor industry based rebate potential by: a) determining an industry sensitivity score for the non-enrolled target vendor, the industry sensitivity score being representative of how sensitive a typical vendor in the same type of business as the non-enrolled vendor is to payment of transaction fees; b) using the industry sensitivity score to determine the target transaction fee rate for the non-enrolled vendor; and c) calculating a target vendor industry based rebate potential, the target vendor industry based rebate potential being the product of the target vendor spend value multiplied by the target transaction fee rate.

Further in this sub aspect, the instructions of the payer marketing application further comprise calculating a non-enrolled vendor rebate potential. The non-enrolled vendor rebate potential may be the sum of the target vendor industry based rebate potential for each target vendor determined to be a non-enrolled vendor.

Further in this sub aspect, the onboard report further including at least one of: i) the non-enrolled vendor rebate potential; and ii) total rebate potential, total rebate potential being the sum of enrolled vendor rebate potential and non-enrolled vendor rebate potential.

Further in this sub aspect, an additional non transitory data structure may comprise a sensitivity score database. The sensitivity score database may associate each industry code of a group of industry codes with a sensitivity rating. As such, determining the industry sensitivity score for each non-enrolled target vendor comprises: i) obtaining the non-enrolled target vendor's industry code, the non-enrolled target vendor's industry code being a selected industry code of the group of industry codes; ii) looking up in the sensitivity score sub database, the sensitivity rating associated with the non-enrolled target vendor's industry code; and iii) determining the industry sensitivity score for the non-enrolled target vendor to be the sensitivity rating associated with the non-enrolled target vendor's industry code.

In another sub aspect, for each enrolled vendor of a subset of the community of enrolled vendors that are paid by more one enrolled payer the record of the vendor community database associated with the enrolled vendor further includes: i) a first enrolled payer spend value, the first enrolled payer spend value representing the amount payable by the first enrolled payer to the enrolled vendor during the period of time; ii) a second enrolled payer transaction fee rate applied to payments to the enrolled vendor by at least a second enrolled payer, the second enrolled payer transaction fee rate being different than the first enrolled payer transaction fee rate; and iii) a second enrolled payer spend value, the second enrolled payer spend value representing the amount payable by the second enrolled payer to the enrolled vendor during the period of time.

As such, determining the target transaction fee rate comprises: i) selecting the first enrolled payer transaction fee rate as the target transaction fee rate if the amount payable by the prospective payer to the enrolled vendor over the period of time is closer to the first enrolled payer spend value than to the second enrolled payer spend value; and ii) selecting the second enrolled payer transaction fee rate as the target transaction fee rate if the amount payable by the prospective payer to the enrolled vendor over the period of time is closer to the second enrolled payer spend value than to the first enrolled payer spend value.

Further in this sub aspect, the instructions of the payer marketing application may further comprise: i) determining that the target vendor is a non-enrolled vendor if identifying attributes of the target vendor from the record of the vendor history file do not match identifying attributes of an enrolled vendor from a record of the community database; ii) for each non-enrolled target vendor, determining a target vendor industry based rebate potential by: a) determining an industry sensitivity score for the non-enrolled target vendor, the industry sensitivity score being representative of how sensitive a typical vendor in the same type of business as the non-enrolled vendor is to payment of transaction fees; b) using the industry sensitivity score to determine the target transaction fee rate for the non-enrolled vendor; and c) calculating a target vendor industry based rebate potential, the target vendor industry based rebate potential being the product of the target vendor spend value multiplied by the target transaction fee rate; and iii) calculating a non-enrolled vendor rebate potential, the non-enrolled vendor rebate potential being the sum of the target vendor industry based rebate potential for each target vendor determined to be a non-enrolled vendor.

In this aspect, the onboard report further including at least one of: i) the non-enrolled vendor rebate potential; and ii) total rebate potential, total rebate potential being the sum of enrolled vendor rebate potential and non-enrolled vendor rebate potential.

In this sub aspect, the system may further include as a non transitory data structure, a sensitivity score database. The sensitivity score database may associate each industry code of a group of industry codes with a sensitivity rating. As such, determining the industry sensitivity score for each non-enrolled target vendor may comprises: i) obtaining the non-enrolled target vendor's industry code, the non-enrolled target vendor's industry code being a selected industry code of the group of industry codes; ii) looking up in the sensitivity score sub database, the sensitivity rating associated with the non-enrolled target vendor's industry code; and iii) determining the industry sensitivity score for the non-enrolled target vendor to be the sensitivity rating associated with the non-enrolled target vendor's industry code.

In another sub aspect, the vendor history file further includes identification of the quantity of payments made by the prospective payer to the enrolled vendor over the period of time. Further, for each enrolled vendor of a subset of the community of vendors that are paid by more one enrolled payer, the record of the vendor community database associated with the enrolled vendor further includes: i) a first enrolled payer spend frequency, the first enrolled payer spend frequency representing the quantity of payments made by the first enrolled payer to the enrolled vendor during the period of time; ii) a second enrolled payer transaction fee rate applied to payments to the enrolled vendor by at least a second enrolled payer, the second enrolled payer transaction fee rate being different than the first enrolled payer transaction fee rate; and ii) a second enrolled payer spend frequency, the second enrolled payer spend frequency representing the quantity of payments made by the second enrolled payer to the enrolled vendor during the period of time.

In this sub aspect, determining the target transaction fee rate comprises: i) selecting the first enrolled payer transaction fee rate as the target transaction fee rate if the quantity of payments made by the prospective payer to the enrolled vendor over the period of time is closer to the first enrolled payer spend frequency than to the second enrolled payer spend frequency; and ii) selecting the second transaction fee rate as the target transaction fee rate if the quantity of payments made by the prospective payer to the enrolled vendor over the period of time is closer to the second enrolled payer spend frequency than to the first enrolled payer spend frequency.

Further in this sub aspect, the instructions of the payer marketing further comprise: i) determining that the target vendor is a non-enrolled vendor if identifying attributes of the target vendor from the record of the vendor history file do not match identifying attributes of an enrolled vendor from a record of the community database; and ii) for each non-enrolled target vendor, determining a target vendor industry based rebate potential by: a) determining an industry sensitivity score for the non-enrolled target vendor, the industry sensitivity score being representative of how sensitive a typical vendor in the same type of business as the non-enrolled vendor is to payment of transaction fees; b) using the industry sensitivity score to determine the target transaction fee rate for the non-enrolled vendor; and c) calculating a target vendor industry based rebate potential, the target vendor industry based rebate potential being the product of the target vendor spend value multiplied by the target transaction fee rate; and iii) calculating a non-enrolled vendor rebate potential, the non-enrolled vendor rebate potential being the sum of the target vendor industry based rebate potential for each target vendor determined to be a non-enrolled vendor.

In this sub aspect, the onboard report further including at least one of: i) the non-enrolled vendor rebate potential; and ii) total rebate potential, total rebate potential being the sum of enrolled vendor rebate potential and non-enrolled vendor rebate potential.

In this sub aspect the system may further comprise a sensitivity score database. The sensitivity score database associates each industry code of a group of industry codes with a sensitivity rating. As such, determining the industry sensitivity score for each non-enrolled target vendor comprises: i) obtaining the non-enrolled target vendor's industry code, the non-enrolled target vendor's industry code being a selected industry code of the group of industry codes; ii) looking up in the sensitivity score sub database, the sensitivity rating associated with the non-enrolled target vendor's industry code; and iii) determining the industry sensitivity score for the non-enrolled target vendor to be the sensitivity rating associated with the non-enrolled target vendor's industry code.

In yet another sub aspect, the vendor history file further includes identification of the quantity of payments made by the prospective payer to the enrolled vendor over the predetermined period of time. For each enrolled vendor of a subset of the community of vendors that are paid by more one enrolled payer, the record of the vendor community database associated with the enrolled vendor further includes: i) a first enrolled payer spend value, the first enrolled payer spend value representing the amount payable by the first enrolled payer to the enrolled vendor during the period of time; ii) a first enrolled payer spend frequency, the first enrolled payer spend frequency representing the quantity of payments made by the first enrolled payer to the enrolled vendor during the period of time; iii) a second enrolled payer transaction fee rate applied to payments to the enrolled vendor by at least a second enrolled payer, the second enrolled payer transaction fee rate being different than the first enrolled payer transaction fee rate; iv) a second enrolled payer spend value, the second enrolled payer spend value representing the amount payable by the second enrolled payer to the enrolled vendor during the period of time; and v) a second enrolled payer spend frequency, the second enrolled payer spend frequency representing the quantity of payments made by the second enrolled payer to the enrolled vendor during the period of time.

In this sub aspect, determining the target transaction fee rate may comprise: i) calculating a first enrolled payer spend volume differential value, the first payer spend volume differential value being a function of the difference between first enrolled payer spend value and the amount payable by the prospective payer to the enrolled vendor over the period of time; ii) calculating a second enrolled payer spend volume differential value, the second enrolled payer volume differential value being a function of the difference between the second enrolled payer spend value and the amount payable by the prospective payer to the enrolled vendor over the period of time; iii) calculating a first enrolled payer spend frequency differential value, the first payer spend frequency differential value being a function of the difference between the difference between the first enrolled payer spend frequency and quantity of payments made by the prospective payer to the enrolled vendor over the period of time; iv) calculating a second enrolled payer spend frequency differential value, the second enrolled payer spend frequency differential value being a function of the difference between the second enrolled payer spend frequency and the quantity of payments made by the prospective payer to the enrolled vendor over the period of time; v) calculating a first enrolled payer weighted average, the first payer weighted average being the average of: a) the first enrolled payer spend volume differential value multiplied by a first coefficient; b) and the first enrolled payer spend frequency differential value multiplied by a second coefficient; vi) calculating a second enrolled payer weighted average, the second enrolled payer weighted average being the average of: a) the second enrolled payer spend volume differential value multiplied by the first coefficient; and b) the second enrolled payer spend frequency differential value multiplied by the second coefficient; vii) selecting the first enrolled payer transaction fee rate as the target transaction fee rate if the first enrolled payer weighted average is less than the second enrolled payer weighted average; and viii) selecting the second enrolled payer transaction fee rate as the target transaction fee rate if the second enrolled payer weighted average is less than the first enrolled payer weighted average.

Further, the instructions of the payer marketing further comprise: i) determining that the target vendor is a non-enrolled vendor if identifying attributes of the target vendor from the record of the vendor history file do not match identifying attributes of an enrolled vendor from a record of the community database; ii) for each non-enrolled target vendor, determining a target vendor industry based rebate potential by: a) determining an industry sensitivity score for the non-enrolled target vendor, the industry sensitivity score being representative of how sensitive a typical vendor in the same type of business as the non-enrolled vendor is to payment of transaction fees; b) using the industry sensitivity score to determine the target transaction fee rate for the non-enrolled vendor; iii) calculating a target vendor industry based rebate potential, the target vendor industry based rebate potential being the product of the target vendor spend value multiplied by the target transaction fee rate; and iv) calculating a non-enrolled vendor rebate potential, the non-enrolled vendor rebate potential being the sum of the target vendor industry based rebate potential for each target vendor determined to be a non-enrolled vendor.

In this aspect, the onboard report further includes at least one of: i) the non-enrolled vendor rebate potential; and ii) total rebate potential, total rebate potential being the sum of enrolled vendor rebate potential and non-enrolled vendor rebate potential.

For a better understanding of the present invention, together with other and further aspects thereof, reference is made to the following description, taken in conjunction with the accompanying drawings. The scope of the invention is set forth in the appended claims.

### BRIEF DESCRIPTION OF THE DRAWINGS

FIG. 1 is a block diagram representing architecture of a system for facilitating the marketing to and on-boarding payers to an electronic payment and remittance system in accordance with an exemplary embodiment of the present invention;

FIG. 2 is a block diagram representing a payer in accordance with an exemplary embodiment of the present invention;

FIG. 3 is a block diagram representing a vendor in accordance with an exemplary embodiment of the present invention;

FIG. 4 is a table diagram representing data elements stored in, and relationships between data elements stored in, a vendor registry of a payment system in accordance with an exemplary embodiment of the present invention;

FIG. 5 is a table diagram representing data elements stored in, and relationships between data elements stored in, a payer registry of a payment in accordance with an exemplary embodiment of the present invention;

FIG. 6a is a table diagram representing data elements stored in, and relationships between data elements stored in, a payment file in accordance with a first exemplary embodiment of the present invention;

FIG. 6b is a table diagram representing data elements stored in, and relationships between data elements stored in, a payment file in accordance with a second exemplary embodiment of the present invention;

FIG. 6c is a table diagram representing data elements stored in, and relationships between data elements stored in, a payment file in accordance with a third exemplary embodiment of the present invention;

FIG. 7a is a ladder diagram representing a combination of data structures and instructions stored in memory and executed by a processor for making payments from each payer of a community of payers to each vendor of a community of vendors, assessing a variable transaction fee to each vendor, and providing a variable rebate to each payer, all in accordance with a first exemplary embodiment of the present invention;

FIG. 7b is a ladder diagram representing a combination of data structures and instructions stored in memory and executed by a processor for making payments from each payer of a community of payers to each vendor of a community of vendors, assessing a variable transaction fee to each vendor, and providing a variable rebate to each payer, all in accordance with a second exemplary embodiment of the present invention;

FIG. 8 is a flow chart representing exemplary instructions stored in memory and executed by a processor for determining a transaction fee to assess on a payment in accordance with an exemplary embodiment of the present invention; and

FIG. 9 is a flow chart representing rebate calculation in accordance with an exemplary embodiment of the present invention.

FIG. 10 is a table diagram representing data elements stored in, and relationships between data elements stored in, a vendor community database in accordance with an exemplary embodiment of the present invention;

FIG. 11 is a flow chart showing exemplary operating steps of a first aspect payer marketing application in accordance with an embodiment of the present invention;

FIG. 12 is an XML file diagram representing data elements stored in, and relationships between data elements stored in, a vendor history file in accordance with an exemplary embodiment of the present invention;

FIG. 13 is a flow chart showing exemplary operating steps of a second aspect of a payer marketing application in accordance with an embodiment of the present invention;

FIG. 14a is a table diagram representing an exemplary industry code database in accordance with an aspect of the present invention;

FIG. 14b is a table diagram representing a matching of sensitivity scores to industry codes in accordance with an exemplary embodiment of the present invention;

FIG. 14c is a table diagram representing payer centric spend scores and criteria for determining a payer centric spend score in accordance with an exemplary embodiment of the present invention;

FIG. 14d is a table diagram representing payer centric frequency scores and criteria for determining a payer centric frequency score in accordance with an exemplary embodiment of the present invention;

FIG. 14e is a table diagram representing network spend scores and criteria for determining a network spend score in accordance with an exemplary embodiment of the present invention;

FIG. 14f is a table diagram representing network frequency scores and criteria for determining a network frequency score in accordance with an exemplary embodiment of the present invention;

FIG. 14g is a table diagram representing weight factors to apply to in accordance with an exemplary embodiment of the present invention;

FIG. 14h is a table diagram representing rate tiers to apply to in accordance with an exemplary embodiment of the present invention; and

FIG. 15 is a diagram representing exemplary rendering of an onboard report in accordance with an aspect of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code/instructions which is encoded within computer readable media accessible to the processor, or a combination of a hardware circuit(s) and a processor or control block of an integrated circuit executing machine readable code encoded within a computer readable media. As such, the term circuit, module, server, application, or other equivalent description of an element as used throughout this specification is intended to encompass a hardware circuit (whether discrete elements or an integrated circuit block), a processor or control block executing code encoded in a computer readable media, or a combination of a hardware circuit(s) and a processor and/or control block executing such code.

It should also be appreciated that table structures represented in this application are exemplary data structures of a non transitory nature embodied in computer readable media or memory, and intended to show the mapping of relationships between various data elements. Other table structures may store similar data elements in a manner that maintains the relationships useful for the practice of the present invention.

Within this application the applicant has depicted and described groups of certain elements. As used in this application, the term group (and the term community) means at least three of the elements. For example, a group of vendors means at least three vendors. When a group, for example a first group, is referred to as being distinct, or distinct from a second group, it means that the first group contains at least one element that is not present in the second group and the second group includes at least one element that is not present in the first group. The use of the term unique with respect to an element within a group or set of elements means that that the element is different then each other element in the set or group.

Within this application, the applicant has used the term database to describe a data structure which embodies groups of records or data elements stored in a volatile or non volatile storage medium and accessed by an application, which may be instructions coded to a storage medium and executed by a processor. The application may store and access the database.

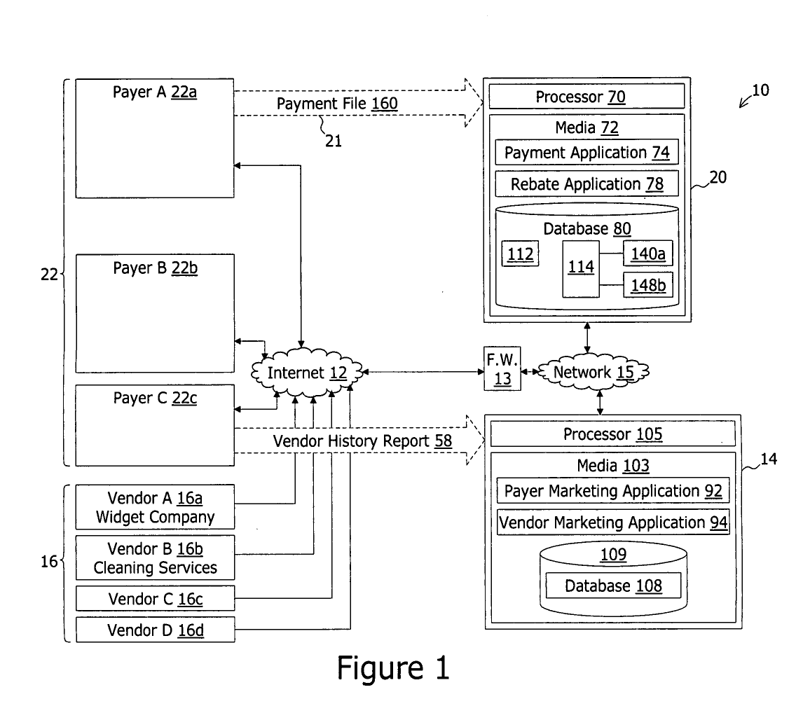

Turning to FIG. 1, an exemplary system 10 includes an automated payment and remittance system 20 for automating payments from each enrolled payer 22a, 22b of a community of payers 22 to each enrolled vendor 16a, 16b, 16c of a community of vendors 16 and assessing a transaction fee to each vendor in conjunction with executing a payment from a payer to the vendor, and providing a variable rebate to the payer.

The transaction fee assessed to the vendor is based on a variable transaction rate. More specifically, the fee is the product of multiplying the amount of the payment by the rate that is applicable to payments made by the particular payer to the particular vendor. The rate is referred to as “variable” because: i) the rate is variable amongst vendors, the same payer may use different rates for different vendors; and ii) the rate is variable amongst payers, the same vendor may be subjected to different rates, based on the particular payer making the payment.

The exemplary system 10 further includes a vendor management system 14 coupled to the payment system 20.

In an exemplary embodiment, the vendor management system 14 is communicatively coupled to the payment system 20 through a secure network 15 such as a local IP network. A firewall 13 may interconnect the secure network 15 to a global network 12 such a the internet which interconnects each enrolled payer 22a, 22b and each vendor enrolled 16a, 16b, 16c with the payment system 20 and the vendor management system 14 utilizing secure connections.

In one aspect, the vendor management system 14 includes a payer marketing application 92 which facilitates marketing the automated payment and remittance system 20 to prospective payers which are typically making accounts payables payments to a group of vendors, at least some of which are enrolled vendors 16a, 16b, 16c within the community of vendors 16.

In another aspect, the vendor management system 14 includes a vendor marketing application 94 which facilitates marketing the automated payment and remittance system 20 to prospective vendors which are typically receiving payments from one or more of the enrolled payers 22a, 22b, 22c and on-boarding those vendors to the system such that they become one of the vendors within the community of vendors 16.

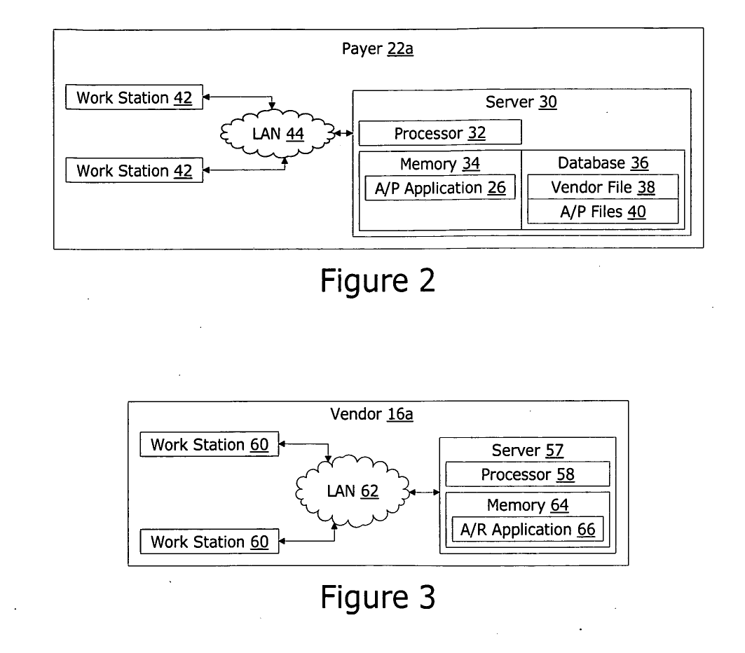

Turning briefly to FIG. 2 in conjunction with FIG. 1, in an exemplary embodiment, each payer, using payer 22a as an example, may be a business that includes at least one computer system or server 30. The computer system(s) or server(s) 30 include at least one processor 32 and associated memory 34 programmed with an accounts payable application 26.

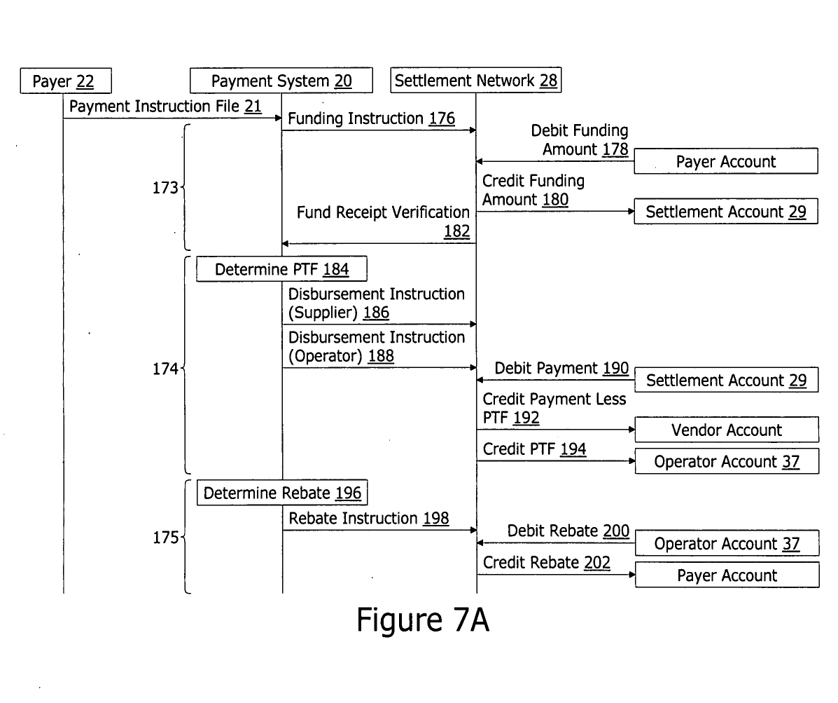

In a typical environment, the computer system(s) or server(s) 30 operating the accounts payable application 26 may be coupled to a local area network 44 and accessed by entitled users of workstations 42 and may be used for managing the payer's accounts payables and issue payments to its vendors. The accounts payable application 26 may issue the payment instructions and/or payment files described with respect to FIGS. 6a, 6b, and 6c.

The accounts payable application 26 utilizes an accounts payable database 36. The accounts payable database may include at least an accounts payable vendor file 38 and AP files 40.

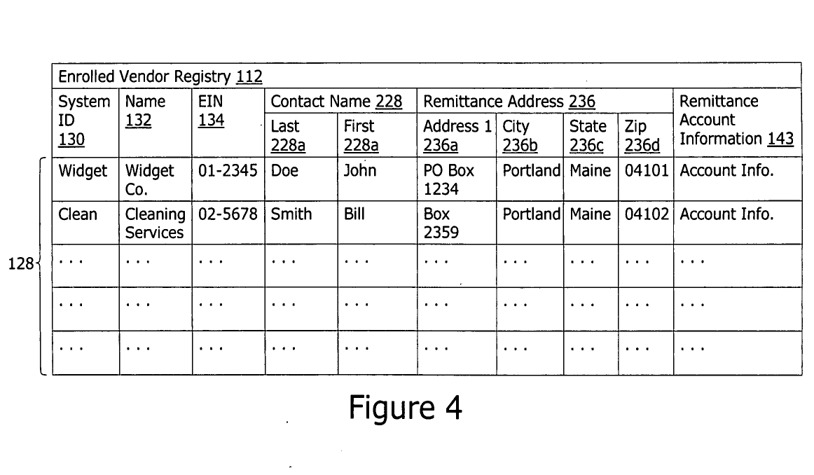

Turning briefly to FIG. 3 in conjunction with FIG. 1, in an exemplary embodiment, each vendor, using vendor 16a for example, may be a business that includes at least one computer system or server 57. The computer system(s) or server(s) 57 include at least one processor 58 and associated memory 64 programmed with an accounts receivable application 66.

In a typical environment, the computer system(s) or server(s) 57 operating the accounts receivable application 66 may be coupled to a local area network 62 and accessed by entitled users of workstations 60 and may be used for managing the vendor's accounts receivables and reconciling payments issued by customers (i.e. payers) against amounts due to the vendor.

Returning to FIG. 1, the payment system 20 may be a computer system of one or more servers comprising at least a processor 70 and computer readable media 72. The computer readable media 72 may include encoded thereon a payment application 74, a rebate application 78, and database 80. Each of the payment application 74 and the rebate application 78 may be a computer program comprising instructions embodied on computer readable media 72 and executed by the processor 42. The database 80 may include non transitory data structures, also referred to as tables, as described herein.

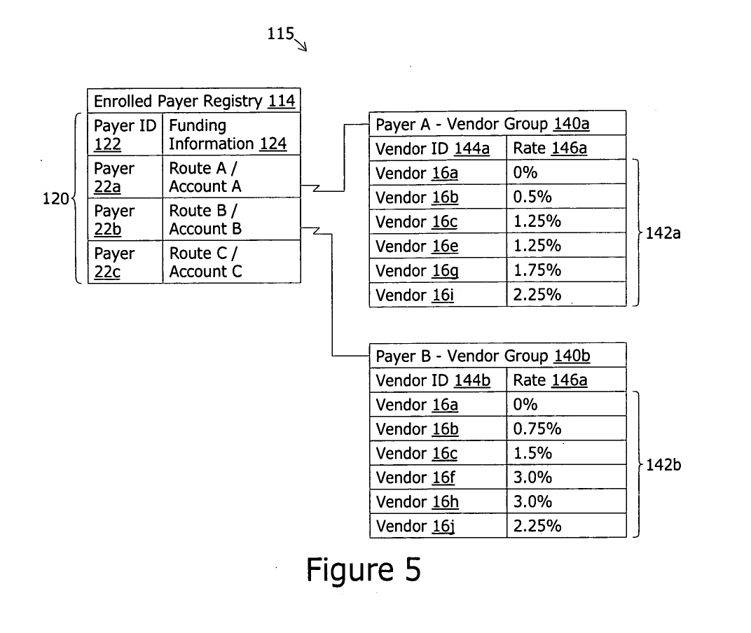

Turning briefly to FIG. 4 in conjunction with FIG. 1, the database 80 may include, as one of the data structures, an enrolled vendor registry 112. The enrolled vendor registry 112 may comprise a group of vendor records 128. The group of vendor records 128 may comprise unique records, each of which is associated with, and identifies, a unique one of the enrolled vendors 16a, 16b, 16c of the community of vendors 16 by inclusion of a unique vendor ID within a system ID field 130 of the record.

Also associated with the vendor may be: i) the vendors name included in a name field 132; ii) the vendor's tax identification number included in a tax ID field 134; iii) the vendor's contact information 228 included in contact information fields 228a, 228b; iv) the vendors remittance address 236 included in remittance address fields 236a, 236b, 236c, 236d; and v) the vendors remittance account information included in a remittance account information field 143.

The vendor's name 132 may be the official name of the entity as recorded in official records of the jurisdiction in which it is formed and as used for titling its bank accounts, including its remittance account.

The vendor's contact information 228 may include the name of an individual in the vendor's accounts receivable department responsible for managing the vendor's accounts receivable matters with the payers 22.

The vendor's remittance address 236 may be an address the vendor typically uses for receiving checks from its customers by regular mail (for example a lock box address).

The vendor's remittance account information 143 may include bank account information (such as routing number and account number) and/or other information needed by the payment system 20 to execute deposits to the vendor's account in accordance with payment authorization instructions provided by a payer.

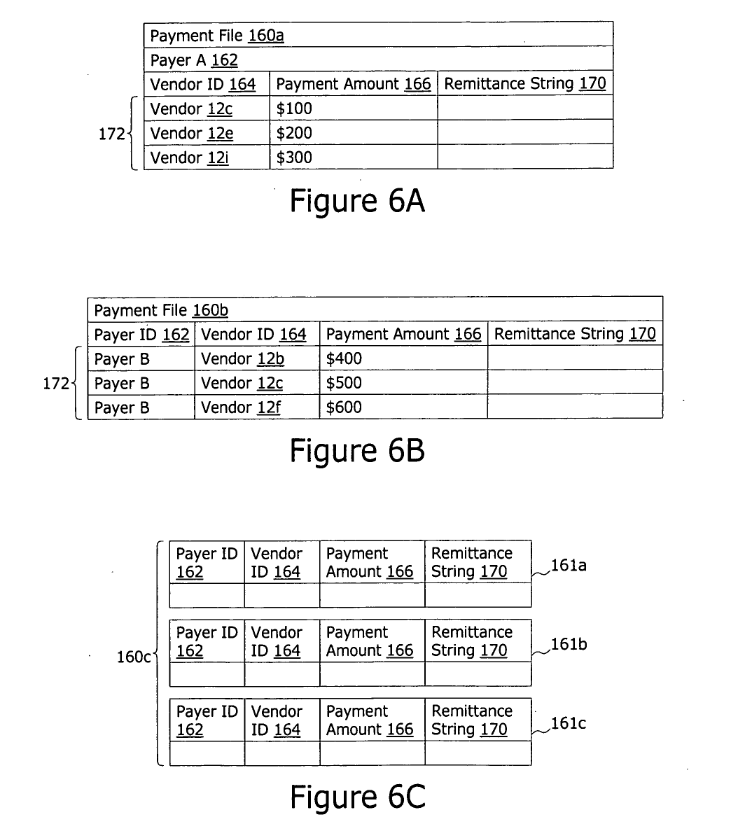

Turning to FIG. 5 in conjunction with FIG. 1, the database 80 may include, as one of the data structures, a data structure 115 which includes, for each payer 22a, 22b, 22c within the community of payers 22, identification of the payer and, in association with identification of the payer, identification of the payer's unique payer vendor subgroup and payer specific transaction rates associate with each enrolled vendor to which the enrolled payer makes payments.

The payer's unique payer vendor subgroup is the group of vendors to which the payer makes payment using the payment system 20. The payer's payer vendor subgroup may be a subset of the community of vendors 16 that consists of fewer than the entire community of vendors 16 and is distinct from each of the other payer's unique payer vendor subgroup.

More specifically, the data structure 115 may include an enrolled payer registry 114. The enrolled payer registry 114, may comprise a group of payer records 120. Each record 120 is associated with, and identifies a unique one of the enrolled payers 22a, 22b, 22c of the community of payers 22 by inclusion of a unique payer ID within a payer ID field 122 of the record.

Also associated with each payer is funding information unique to the payer and stored in at least one funding information field 124 of the record. The funding information may include bank account information (which may be a routing number and account number) identifying a bank deposit account belonging to the payer and/or other information used by the payment system 20 to execute payments from the account belonging to the payer to an account associated with a vendor within the payer's vendor subgroup in accordance with payment authorization instructions provided by the payer.

Each record of the enrolled payer registry 114 may be associated with a unique payer vendor group table 140, for example the record for payer 22a (with payer ID “Payer A”) may be associated with payer vendor group table 140a and the record for payer 22b (with payer ID “Payer B”) may be associated with payer vendor group table 140b.

Payer vendor group table 140a, associated with payer 22a, may include a vendor ID for each vendor in Payer 22a's unique payer vendor subgroup. More specifically, the payer vendor group table 140a may include a group of records 142a with each record being unique to one of the enrolled vendor's within payer 22a's payer vendor subgroup.

Each record 142a may include a vendor ID within a vendor ID field 144a which identifies the enrolled vendor (from system ID field 130 of FIG. 4) and associates the record with the vendor. For example, payer 22a's payer vendor subgroup may consists of six (6) enrolled vendors, vendor 16a, vendor 16b, vendor 16c, vendor 16e, vendor 16g, and vendor 16i, which is fewer then all enrolled vendors within the community of vendors 16.

The payer vendor group table 140a also associates each enrolled vendor with a transaction rate that applies to payments from Payer 22a to the enrolled vendor. More specifically, a transaction rate may be specified as a percentage or fractional value within a transaction rate field 146a of the record 142a associated with the vendor.

For example, identification of zero percent (0.00%) is associated with identification of Vendor 16a indicating that a transaction rate of zero percent (0.00%) applies to payments from Payer 22a to Vendor 16a. A transaction rate of one half percent (0.50%) is associated with identification of Vendor 16b, a transaction rate of one and one quarter percent (1.25%) is associated with identification of Vendor 16c, and Vendor 16e, a transaction rate of one and three quarters percent (1.75%) is associated with identification of Vendor 16g, and a transaction rate of two and one quarter percent (2.25%) is associated with identification of vendor 16i.

Payer 22b's payer vendor subgroup may consists of six (6) enrolled vendors, vendor 16a, vendor 16b, vendor 16c, vendor 16f, vendor 16h, and vendor 16j, which is fewer then all vendors within the community of vendors 16. Within the vendor group table 140b, each of such vendors is associated with a unique record that includes the Vendor ID within the vendor ID field 144b.

The payer vendor group table 140b also associates each enrolled vendor with a transaction rate that applies to payments from payer 22b to the enrolled vendor. More specifically, a transaction rate may be specified as a percentage or fractional value within a transaction rate field 146b of the record 142b associated with the vendor.

For example, identification of a transaction rate of zero (0.00%) is associated with identification of Vendor 16a, a transaction rate of three quarters of a percent (0.75%) is associated with identification of Vendor 16b, a transaction rate of one and one half percent (1.50%) is associated with identification of Vendor 16c, a transaction rate of three percent (3.00%) is associated with identification of Vendor 16f and Vendor 16h, and a transaction rate of two and one quarter percent (2.25%) is associated with identification of vendor 16j.

Returning to FIG. 1, in operation, the payment and remittance system 20 processes payments, each payment being initiated by one of the enrolled payer's within the community of payers 22, for payment of a payment amount from the payer's account to one of the enrolled vendors within the community of vendors 16. More specifically, from each enrolled payer 22a, 22b, 22c of the community of payers 22, the payment system 20 receives a payment instruction file identifying payments to process for the payer. For example, arrow 21 represents receipt of a payment instruction file 160 from payer 22c identifying payments to process for payer 22c, the payments being payments to a group of vendor's within the payer 22a's payer vendor subgroup.

Referring to FIG. 6a a first exemplary payment instruction data structure, or payment instruction file is depicted. Referring to FIG. 1 in conjunction with FIG. 6a, the payment file 160a may comprises identification of the payer within a payer ID field 162 (Payer ID “Payer A” representing payer 22a) and, associated with that payer ID field 162, a group of unique records 172, each record representing a unique payment instruction. Each record 172 includes: i) identification of the vendor to which payment is to be made by inclusion of the vendor's Vendor ID (from the enrolled vendor registry 112) within a vendor ID field 164; ii) identification of the amount of the payment to be made to the vendor by inclusion of a payment amount within a payment amount field 166; and iii) remittance information, which may be alpha numeric information identifying what payable is being paid, within a remittance string field 170. The remittance information may identify the vendor's invoice being paid, goods or services for which payment is being made, or other aspects of an underlying transaction between the payer and vendor giving rise to the payment associated with the record.

FIG. 6b represents a second exemplary payment instruction data structure, or payment instruction file. Referring to FIG. 1 in conjunction with FIG. 6b, the payment file 160b may comprise a group of unique records 172, each record representing a unique payment instruction. Each record 172 includes: i) identification of the payer within a payer ID record 162 (i.e. Payer ID “Payer B” representing payer 22b)); ii) identification of the vendor to which payment is to be made by inclusion of the vendor's Vendor ID (from the enrolled vendor registry 112) within a vendor ID field 164; iii) identification of the amount of the payment to be made to the vendor by inclusion of a payment amount within a payment amount field 166; and iv) remittance information, which may be alpha numeric information identifying what payable is being paid, within a remittance string field 170. Again, the remittance information may identify the vendor's invoice being paid, goods or services for which payment is being made, or other aspects of an underlying transaction between the payer and vendor giving rise to the payment associated with the record.

FIG. 6c represents a third exemplary payment instruction data structure, or payment instruction file. Referring to FIG. 1 in conjunction with FIG. 6c, a group of independent payment instructions, comprising unique payment instructions 161a, 161b and 161c, may in the aggregate be a payment instruction file 160c.

Each payment instruction may include: i) identification of the payer within a payer ID record 162; ii) identification of the vendor to which payment is to be made by inclusion of the vendor's Vendor ID (from the enrolled vendor registry 112) within a vendor ID field 164; iii) identification of the amount of the payment to be made to the vendor by inclusion of a payment amount within a payment amount field 166; and iv) remittance information, which may be alpha numeric information identifying what payable is being paid, within a remittance string field 170. Again, the remittance information may identify the vendor's invoice being paid, goods or services for which payment is being made, or other aspects of an underlying transaction between the payer and vendor giving rise to the payment associated with the record.

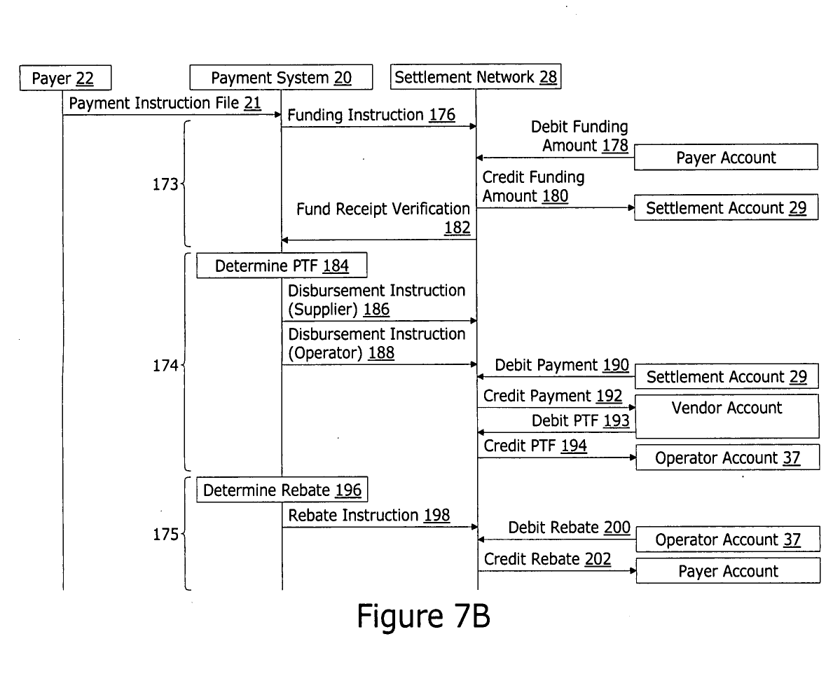

Referring to the ladder diagram of FIG. 7a in conjunction with FIG. 1, in an exemplary embodiment of operation, the payment system 20 receives a payment file, for example payment file 160a (FIG. 6a) from payer 22a, as represented by step 21. The payment instruction file may be transferred via a secure connection over the network 12 which may include implementing encryption of the connection and/or the file transferred over the connection.

Upon receiving and authenticating the payment file 160, the payment system 20, or more specifically, the processor 70 executing the payment application 74, performs funding steps 173 to transfer a funding amount equal to the aggregate or sum of the amount of all payments in the payment file 160 from the payer's account (funding information 124, FIG. 5) to a settlement account 29.

The funding steps 173 may include generating a funding instruction 176 to a settlement network 28 to which the payment system 20 is coupled. The funding instruction 176 may include initiation of a debit transaction to debit the funding amount from the payer's transaction account as represented by step 178 and a credit transaction to credit to the settlement account 29 the funding amount as represented by step 180. The funding steps 173 may further include the settlement network 28 providing a message 82 back to the payment system 20 verifying that the funding amount has been received in the settlement account 29.

The debit of the payer's account and credit to the settlement account may be by transfer through a settlement network 28. The settlement network 28 may be a bank's internal settlement network if both accounts are held at the same bank. The settlement network 28 may also be separate from the payment system 20, such as the Fedwire settlement network or the ACH settlement network, or may be a proprietary component of the payment system 20, such as a bank card association settlement network. In an embodiment wherein the settlement network 28 is part of the payment system 20, the settlement network 28 may be an application comprising instructions stored on the computer readable medium 72 and executed by processor 70, such instructions implementing the credit and debit transactions as described in this specification.

After the funding amount is received in the settlement account 29, disbursement steps 174 are performed for each payment represented in the payment file. In executing the disbursement steps 174 for a payment, the payment system 20 identifies a payment transaction fee to apply to the payment at step 184.

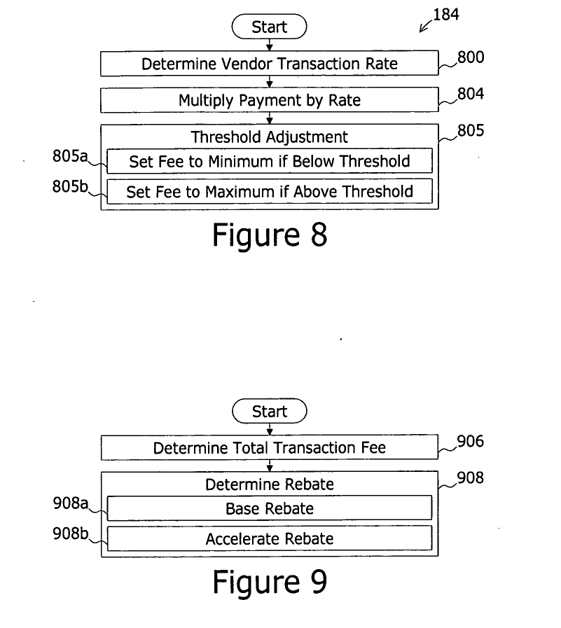

Turning briefly to flow chart of FIG. 8, in conjunction with FIG. 5 step 800 represents identifying the payment transaction fee to apply to a payment.

For example, the first payment represented in payment file 160a, represents a payment of $100 from payer 22a to vendor 16c. In this example, the payment system 20, at step 800, looks up, in the payer vendor group table 140a associated with payer 22a, the transaction rate identified in the record associated with vendor 16c (1.25%).

Step 804 represents determining the payment transaction fee by multiplying the amount of the payment (i.e. $100 in the example) by the applicable transaction rate (1.25%) to yield the payment transaction fee (i.e. $1.25 in the example).

Step 805 represents making a threshold adjustment to the transaction fee determined at step 804 in the event the transaction fee, as determined at step 904, is below a minimum threshold or above a maximum threshold.

Sub-step 805a represents setting the transaction fee to a predetermined minimum transaction fee in the event the transaction fee, as determined at step 804 is below a threshold equal to the minimum transaction fee. For example, if the predetermined minimum transaction fee is $0.75 and the transaction fee as determined at step 804 is less than $0.75, then, at step 805a the transaction fee would be reset to $0.75.

Sub-step 805b represents setting the transaction fee to a predetermined maximum transaction fee in the event the transaction fee, as determined at step 804 is above a threshold equal to the maximum transaction fee. For example, if the predetermined maximum transaction fee is $20.00 and the transaction fee as determined at step 804 is above $20.00, then, at step 805b the transaction fee would be reset to $20.00.

Returning to FIG. 7a, step 186 represents the payment system 20 generating disbursement instructions 186 and 188 to initiate: i) a debit transaction, or multiple debit transactions, to debit the payment amount from the settlement account 29 as depicted by step 190; ii) a credit transaction to credit the payment amount less the transaction fee to the vendor's transaction account as depicted by step 192; and iii) a credit transaction to credit the transaction fee to an operator account 37 as depicted by step 194. The debit(s) of the settlement account and credits to the vendor's transaction account and operator account by funds transfer using the settlement network 28.

As discussed, the payment system 20 will complete the disbursement steps 174 for each payment within the payment file 160a, which for the second payment represented in the payment file 160a (i.e. a payment of $200 to vendor 16e) includes identifying a payment transaction fee to apply to the second payment at step 184, using the process described with respect to FIG. 8, and generating the disbursement instructions to effect the credits and debits as discussed with respect to steps 186 through 194.

Similarly for the third payment represented in the payment file 160a (i.e. a payment of $300 to vendor 16i) includes identifying a payment transaction fee to apply to the third payment at step 184, using the process described with respect to FIG. 8, and generating the disbursement instructions to effect the credits and debits as discussed with respect to steps 186 through 194.

It should be appreciated that the disbursement instructions to effect the credits and debits as discussed with respect to steps 186 through 194, for each of multiple transactions, may be grouped in batches, more specifically, the instructions associated with each of the first payment, second payment, and third payments may be transmitted at the same time as part of a batch.

Although the foregoing description of the funding instructions 173 contemplate funding the settlement account for the aggregate amount of all payments within the payment file through a single funding transaction. In an alternative, the funding instructions 173 may be independently performed for each payment within the payment file, in each case funding only the amount of the particular payment to the settlement account.

After disbursement instructions 174 are executed for each payment within the payment file 160, rebate instructions 175 may be executed for calculating and paying a rebate to the payer. More specifically, step 196 represents calculating a rebate due to the payer.

In a preferred embodiment, the rebate steps 175 may be performed only after multiple payment files are received from the payer over a set period of time, for example payment steps 175 may be performed only once per month for calculating a rebate based on the group of all payments made by the payer during the previous month period preceding the calculation and payment of the rebate. However, other embodiments are contemplated. For example, the payment system 20 may perform the rebate steps 175 once per payment, meaning the payment system 20 may calculate and disburse a rebate to the payer on each payment within the payment file.

Alternatively, the payment system 20 may perform the rebate steps 175 once for all payments within the payment file, meaning the payment system 20 may calculate and disburse a rebate to the payer based at least in part on the aggregate of the payments, or the aggregate amount of the payments, within the payment file.

In yet another alternative, the rebate steps 175 may be performed only after multiple payment files are received from the payer which in the aggregate total a certain payment value. For example the aggregate value of all payments made by the payer achieves a threshold value which triggers performance of the payment steps 175 and payment of a rebate based on payments used for calculating the aggregate total.

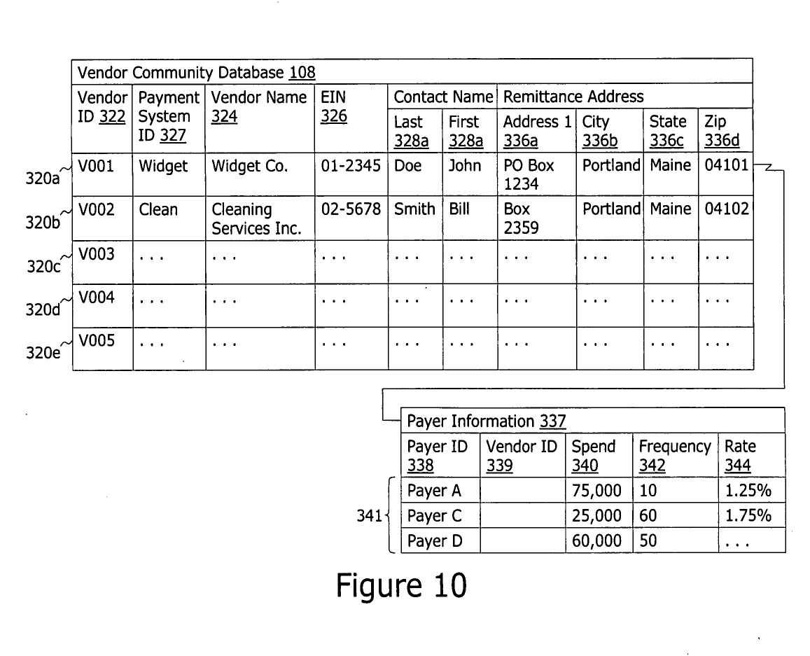

Turning to FIG. 9, exemplary steps for determining a rebate amount in an embodiment where the rebate steps 175 are performed only after multiple payment files are received from the payer over a set period of time are shown.

Step 906 represents determining the total transaction fee. The total transaction fee is the sum of the transaction fee charged on each payment made by the payer over the set period of time.

Step 908 represents determining the amount of the rebate. The rebate amount may be a fraction of the total transaction fee, the fraction being less than one. Or, stated another way, the rebate amount on the aggregate of a group of payments made by the payer may be a fraction of the sum of the aggregate transaction fees applied to the each payment of the group of payments, or a fraction of the of the aggregate transaction fees applied to each payment of the group of payments above a minimum transaction fee threshold.

More specifically, step 908 may represent determining a rebate amount, the rebate amount being the sum of: i) a base rebate calculated at step 908a to be the product of the total transaction fee multiplied by a base rebate fractional value between zero and one; and ii) an accelerated rebate calculated at step 908b to be the product of that portion of the total transaction fee in excess of a predetermined threshold value multiplied by an accelerated rebate fractional value between zero and one.

Returning to FIG. 7a, after the amount of the rebate is determined, the payment system 20 may generate a rebate instruction 198 to initiate: i) a debit transaction to debit the amount of the rebate from the operator account 37 as depicted by step 200 and ii) a credit transaction to credit the amount of the rebate to the payer's account as depicted by step 202.

Referring to the ladder diagram of FIG. 7b in conjunction with FIG. 1, in a second exemplary embodiment of operation, the payment system 20 receives a payment file, for example payment file 160a (FIG. 6a) from payer 22a, as represented by step 21. The payment instruction file may be transferred via a secure connection over the network 20 which may include implementing encryption of the connection and/or the file transferred over the connection.

Upon receiving and authenticating the payment file 160, the payment system 20, or more specifically, the processor 70 executing the payment application 74, performs funding steps 173 to transfer a funding amount equal to the aggregate or sum of the amount of all payments in the payment file 160 from the payer's account to the settlement account 28 as described in more detail with respect to FIG. 7a.

After the funding amount is received in the settlement account 28, disbursement steps 174 are performed for each payment represented in the payment file. In executing the disbursement steps 174 for a payment, the payment system 20 identifies a payment transaction fee to apply to the payment at step 184 as described with respect to FIG. 8.

Step 186 represents the payment system 20 generating disbursement instructions 186 and 188 to initiate: i) a debit transaction, or multiple debit transactions, to debit the payment amount from the settlement account 29 as depicted by step 190; ii) a credit transaction to credit the payment amount to the vendor's transaction account as depicted by step 192; iii) a debit transaction to debit the transaction fee from the vendor's transaction account as depicted at step 193; and iv) a credit transaction to credit the transaction fee to the operator account 37 as depicted by step 194.

As discussed, the payment system 20 will complete the disbursement steps 174 for each payment within the payment file 160a, which for the second payment represented in the payment file 160a (i.e. a payment of $200 to vendor 16e) includes identifying a payment transaction fee to apply to the second payment at step 184, using the process described with respect to FIG. 8, and generating the disbursement instructions to effect the credits and debits as discussed with respect to steps 186 through 194.

Similarly for the third payment represented in the payment file 160a (i.e. a payment of $300 to vendor 16i) includes identifying a payment transaction fee to apply to the third payment at step 184, using the process described with respect to FIG. 8, and generating the disbursement instructions to effect the credits and debits as discussed with respect to steps 186 through 194.

It should be appreciated that the disbursement instructions to effect the credits and debits as discussed with respect to steps 186 through 194, for each of multiple transactions, may be grouped in batches. More specifically, the instructions associated with each of the first payment, second payment, and third payments may be transmitted at the same time as part of a batch.

After disbursement instructions 174 are executed for each payment within the payment file 160, rebate instructions 175 may be executed for calculating and paying a rebate to the payer as describe with respect to FIG. 9.

Returning to FIG. 1, the vendor management system 14 may be a computer system of one or more servers comprising at least a processor 105 and computer readable media 103. The computer readable media 103 may include encoded thereon a payer marketing application 92 and a vendor marketing application 94. Each of the payer marketing application 92 and the vendor marketing application 94 may be a computer program comprising instructions embodied on computer readable media 103 and executed by the processor 105. The database 109 may include non transitory data structures, also referred to as tables, as described herein.

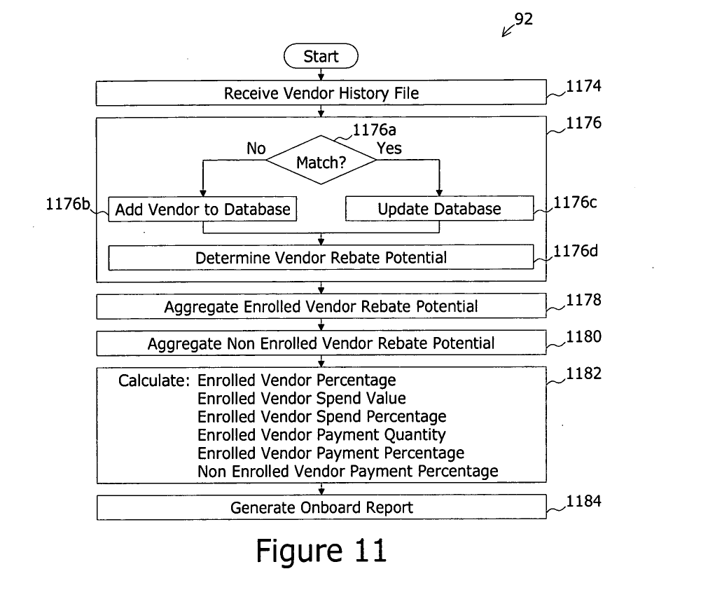

Turning to FIG. 10, the database 109 may include a vendor community database 108. The vendor community database 108 comprises a group of unique records 302, each record being uniquely associated with, and identifying a vendor by way of a unique vendor ID value in a vendor ID field 322. The vendors represented in the records 302 of the vendor community database 108 include both enrolled vendors, for example enrolled vendors 16a and 16b represented by records 320a and 320b, and other vendors within the community of vendors 16 which are known to exist and may be paid by enrolled payers 22a, 22b, 22c, or prospective payers, but are not enrolled to receive payments through the payment system 20. For those enrolled vendors 16a, 16b, 16c, 16d, a payment system ID field 327 stores the system ID from the system ID field 130 of the enrolled vendor registry 112 (FIG. 4).

Also included in the record are the following identifying attributes of the vendor, if known about the vendor: i) the vendor's name stored in a name field 324, ii) the vendor's EIN stored in an IEN field 326 iii) the contact name of an individual at the vendor responsible for accounts receivables stored in contact name fields 328a, 328b, iv) remittance address information stored in remittance address fields 336a, 336b, 336c, 336d; and vi) payer information 337.

The payer information 337 may be in the form of a linked table which, for each vendor, includes a plurality of records 339. For a non-enrolled vendor, the record includes identification of a payer (enrolled or prospective) making payments to the vendor (by check or other means because the vendor is not enrolled for payments through the system 20) in a payer ID field 338 which, for enrolled payers, may be the payer ID of record 122 of the enrolled payer registry 114 FIG. 5. The record further includes a spend value within a spend field 340. The spend value represents the amount paid or payable to the vendor by the enrolled or prospective payer over a predetermined period of time such as one year. The record further includes a spend frequency within a frequency field 342. The spend frequency represents the quantity of payments made by the enrolled payer or prospective payer to the vendor over the predetermined period of time. A rate field 344 remains unpopulated.

For an enrolled vendor, records 341 of the payer information table 227 may be segmented into: i) a first group of records, each of which uniquely associates with an enrolled payer which make payments to the enrolled vendor; and ii) a second group of records, each of which uniquely associated with a prospective payer which makes payments to the vendor.

In both segments, the record includes identification of the enrolled or prospective payer in a payer ID field 338 which, for enrolled payers, may be the payer ID of record 122 of the enrolled payer registry 114 FIG. 5.

The record 341 further includes a Vendor ID field 339 which is the payer specific vendor ID—meaning the vendor ID assigned to the vendor within the payer's proprietary accounts payable system 26 (FIG. 2).

The record 341 further includes a spend value within a spend field 340. The spend value represents the amount paid or payable to the enrolled vendor by the enrolled payer or prospective payer over a predetermined period of time such as one year. The record further includes a spend frequency within a frequency field 342. The spend frequency represents the quantity of payments made by the enrolled payer or prospective payer to the enrolled vendor over the predetermined period of time. For the records associated with an enrolled payer, the rate field 344 includes, within a transaction rate field 344, the transaction rate applied to payments by the enrolled payer to the enrolled vendor—from field 146 of the payer's payer vendor group table 140.

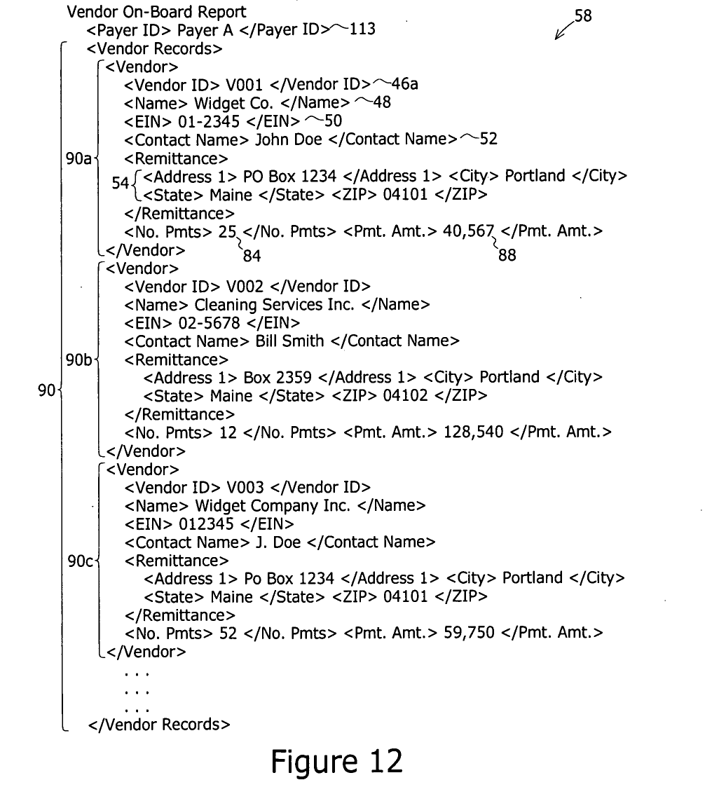

The flow chart of FIG. 11 shows exemplary steps representing the instructions of the payer marketing application 92 coded to the computer readable media 103 and executed by processor 105.

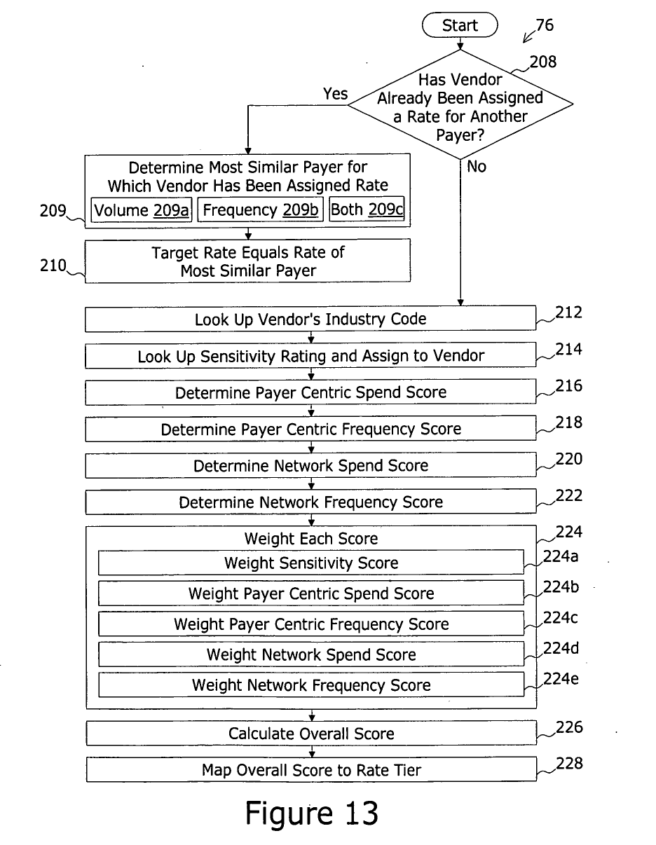

Step 1170 represents receiving a vendor history file 58 from a prospective payer. Turning briefly to FIG. 12, an exemplary vendor history file 58, as exported from a prospective payers accounts payable application 26 (FIG. 2) is represented. While the exemplary vendor history file 58 is structured as an XML file, those skilled in the art will recognize that a particular file structure is a matter of design choice.

The vendor history file 58 associates the prospective payer with a list of target vendors to which the prospective payer makes disbursements and, for each such target vendor, various information useful for identifying the target vendor, identification of the number of payments made to the target vendor over a predetermined period of time such as one year, and identification of the aggregate amount of all payments made to the target vendor over the predetermined period of time

More specifically, the vendor history file 58 may include a group of unique vendor records 90. Each vendor record 90 uniquely represents a target vendor to which disbursements are made by the prospective payer generating the vendor history file 58.

In more detail, each record 90 may include permutations of the following data from the a record corresponding to the target vendor in the payer's accounts payable vendor file 38: i) the vendor ID 46a populated to a vendor ID field; ii) the vendor name 48 populated to a vendor name field; iii) the employer identification number (EIN) 50 populated to an EIN field; iv) the contact name 52 populated to a contact name field; v) the remittance address 54 populated to a remittance address field(s); vi) a payer count value 84 (representing total quantity of payments made to the vendor over the predetermined period of time) populated to a payment count field; and vii) a payment amount value 88 (representing aggregate amount of all payments made to the vendor over the predetermined period of time) populated to a payment amount field.

Returning to FIG. 11, step 1176 represents normalizing and importing vendor information from each target vendor record of the vendor history file 58 to a record uniquely associated with the target vendor in the vendor community database 108.

Returning to FIG. 10 in conjunction with FIG. 11 and FIG. 12, normalizing and importing vendor information into the vendor community database 108 comprises, at step 1176a: i) determine that the target vendor is an enrolled target vendor if identifying attributes of the target vendor from the record of the vendor history file 58 match identifying attributes of an enrolled vendor from an existing record 320 of the vendor community database 108; and ii) determining that the target vendor is a non-enrolled existing target vendor if identifying attributes of the target vendor from the record of the vendor history file 58 match an existing vendor in the vendor community database 108 that is not an enrolled vendor—but does not match identifying attributes of an enrolled vendor from the vendor community database; and iii) determining that the target vendor is a non-enrolled non-existing target vendor if identifying attributes of the target vendor from the record of the vendor history file 58 do not match identifying attributes of any vendor from the vendor community database.

If the target vendor does not match any existing record in the vendor community database 108, a new record is written at step 1172b, including normalizing and mapping the information about the target vendor from the prospective payer's vendor history file 58 to the vendor community database 108. Normalizing and mapping includes, for example, if the vendor history file 58 includes a field labeled “Name” the payer marketing 92 may identify that the data content of that field is to map to the normalized field entitled “Vendor Name”. For purposes of converting content, the payer marketing 92 may, for example, left justify the content within the field and convert any abbreviations for company or incorporated (i.e. Co. or Inc.) to the full word.

Other formatting conversions may include mapping “many to one” or “one to many” wherein multiple data fields within a vendor history file 58 are mapped to a single field of the vendor community database 108 which includes all data elements. For example, if the vendor history file 58 includes a date as three independent fields “Day”, “Month”, “Year”, all three fields could map to a single “Date” field formatted as DD-MM-YY. Similarly if a vendor history file 58 were to include a single date field and the normalized format required three independent fields, the payer marketing 92 could populate each of the three normalized fields with data from the single field. This “many to one” and “one to many” concept may also apply to address fields such as a remittance address.

Other formatting conversions may include converting ASC II text to numeric values or numeric values to ASC II text, left or right justifying, and adding or decimating leading or trailing zeros. For example, an ASC II 5 digit zip code may be converted to a numeric Zip+4 format by converting the ASC II to numeric and adding zeros if the “+4” is not available.

If the vendor is already represented by a record in the vendor community database 108, either an enrolled vendor or a non-enrolled vendor, the applicable record 320 is updated at step 1176c. More specifically, the information from the prospective payer's vendor history file 58 is normalized and mapped into the existing matching record. If the existing record is missing information that is present in the vendor history file 58, such missing information is added to the record.

In all cases, the payer information is updated by adding a record to the payer information table 337 to uniquely associate with the prospective payer. Such added record includes identification of the prospective payer by payer ID, the vendor ID used by the prospective payer to identify the vendor, the spend 340 (i.e. aggregate payment value paid or payable by the prospective payer to the vendor over the predetermined period of time), and the frequency 342 (i.e. total quantity of payments made by the prospective payer to the vendor over the predetermined period of time).

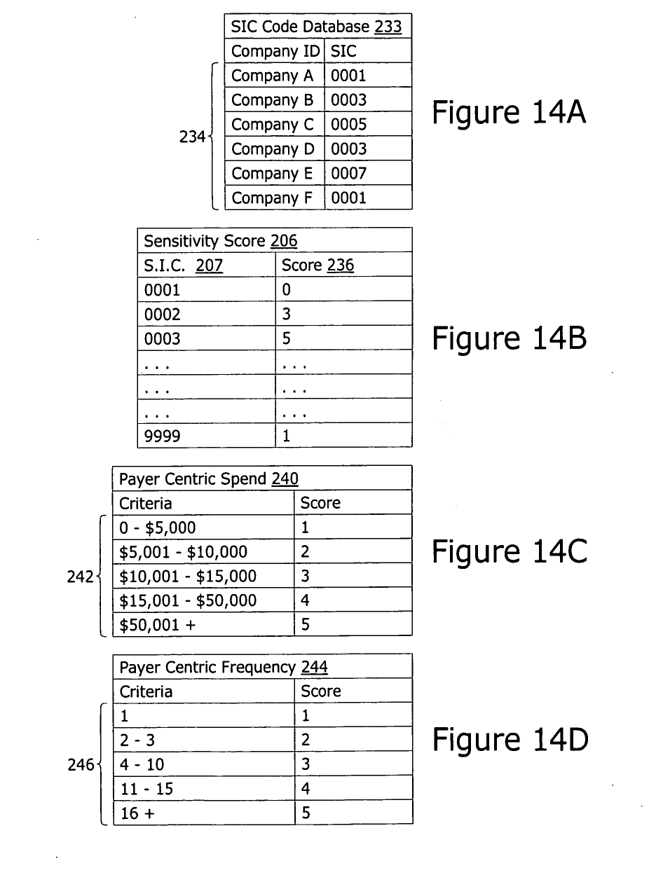

Whether the vendor matched and existing record or not, a vendor rebate potential is determined at step 1176d. FIG. 13 represents exemplary steps of the payer marketing application 92 which may be coded to the compute readable media 103 and executed by the processor 105. With reference to FIG. 13, step 176d may represent, for the vendor, executing exemplary steps of the payer marketing application 92 to determine rebate potential. Step 208 represents determining whether the vendor is an enrolled vendor that has already been assigned a rate by another payer—similar to the determination made with respect to step 1176a of FIG. 11.

If the vendor is an enrolled vendor that has already been assigned a rate by one or more other payers, the payer marketing application 92 determines an enrollment based rebate potential for the vendor at steps 209 and 210.

More specifically, step 209 represents determining which of one or more enrolled payers making payments to the enrolled target vendor has the most similar payer/vendor relationship with the target vendor as the prospective payer and step 210 represents selecting the rate in use by the enrolled payer with the most similar relationship as a target rate for the enrolled target vendor.

More specifically, if the target vendor has an assigned rate for only one enrolled payer, that one enrolled payer would be the payer with the most similar payer/vendor relationship.

If the vendor has an assigned rate with more than one enrolled payer, the other payer which pays the vendor the most similar annual payment volume and/or the most similar payment frequency would be the payer with the most similar payer/vendor relationship.

Sub step 209a represents selecting the enrolled payer with the most similar payer/vendor relationship based on selecting the enrolled payer with the most similar spend volume over the predetermined period of time. More specifically, selecting a first enrolled payer as most similar if the amount paid, or payable by the prospective payer to the enrolled vendor over the period of time is closer to the first enrolled payer spend value than to all other enrolled payer spend values. Which further means selecting a second enrolled payer transaction fee rate as the target transaction fee rate if the amount payable by the prospective payer to the enrolled vendor over the period of time is closer to the second enrolled payer spend value than to the first enrolled payer spend value and all other enrolled payer spend values. The target rate for the target vendor is then the rate of the selected similar payer.

Sub step 209b represents selecting the enrolled payer with the most similar payer/vendor relationship passed on payment quantity based on selecting the enrolled payer with the most similar quantity of payments made to the payer over the predetermined period of time. More specifically, selecting a first enrolled payer as the most similar payer if the quantity of payments made by the prospective payer to the target vendor during the period of time is closer to the first payer enrolled payer spend frequency than to all other enrolled payer spend frequency. Which further means selecting a second enrolled payer as most similar if the quantity of payments made by the prospective payer to the target vendor during the period of time is closer to the second enrolled payer spend frequency than to the first enrolled payer spend frequency and all other enrolled payer frequencies. The target rate for the target vendor is then the rate of the selected similar payer.

Step 209c represents selecting the enrolled payer with the most similar payer/vendor relationship (and using that enrolled payer's rate as the target rate for the vendor) based on a weighted average of similarity based on payment quantity and similarity based on payment frequency. More specifically, step 209c represents: i) calculating an enrolled payer spend volume differential value for each enrolled payer, the enrolled payer spend volume differential value being a function of the difference between the enrolled payer spend value and amount payable by the prospective payer to the enrolled vendor over the period of time; ii) calculating an enrolled payer spend frequency differential value for each enrolled payer, the enrolled payer spend frequency differential value being a function of the difference between the enrolled payer spend frequency and the quantity of payments made by the prospective payer to the enrolled vendor over the period of time; iii) calculating a weighted average for each enrolled payer, the weighted average being the average of: a) the enrolled payer spend volume differential value multiplied by a first coefficient; and b) the payer spend frequency differential value multiplied by a second coefficient; iv) selecting the enrolled payer with the lowest weighted average as the most similar payer.

In all cases, at step 210, the target rate assigned to the target vendor, for payments by the prospective payer, would be the same rate that is in effect with the most similar other payer. And, returning to FIG. 11, an enrollment based rebate potential is determined at step 1176d by multiplying the target rate assigned to the target vendor by the spend volume over the period of time from the prospective payer's vendor history file 58.

Returning to FIG. 13, if at step 208 it is determined that the target vendor has not already been assigned a rate for payments by any other payers, the payer marketing application 92 executes steps 212 through 230 to assign an industry based target rate to the target vendor which is used to calculate an industry based rebate potential at step 1176d of FIG. 11.

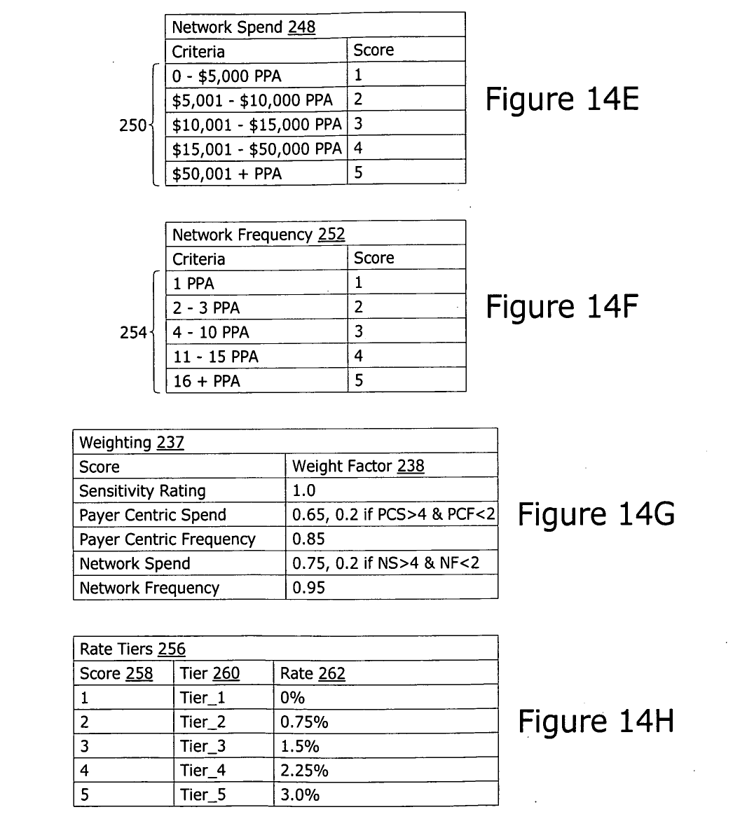

Step 212 represents determining the target vendor's industry code. The payer marketing application 92 may query a SIC code database. Turning to FIG. 14a, an exemplary SIC code database 232 is represented.

The SIC code database 232 may associate the name of each company within a group of companies 234 with the company's industry code. Each company may be identified by its name, tax ID number, or other identifying attributes. In querying the SIC code database 232, the payer marketing application 92 may provide the target vendor's name, tax ID number, or other identifying attributes and receives, in response, the target vendors industry code.

The SIC database 233 may be a remote database accessible over the internet 12 as depicted in FIG. 1, a local database coupled to the system 14, or a local database that is part of database 109 of system 14.

Returning to FIG. 13, step 214 represents determining the target vendor's industry sensitivity. More specifically, referring briefly to FIG. 14b, an exemplary sensitivity score database 206 is shown. Step 214 may comprise determining the score by looking up the industry sensitivity score 236 associated with the target vendor's industry code in the sensitivity score database 206. The sensitivity score database may be a remote database accessible over the internet 12, a local database coupled to the system 14, or a local database that is part of database 109 of system 14.

Returning to FIG. 13, step 216 represents determining the target vendor's payer centric spend score. The target vendor's payer centric spend score is a function of the aggregate value of all payments expected to be made by the prospective payer to the target vendor over the predetermined period of time and may be an integer value of one (1) through five (5).

The aggregate amount of payments expected to be made by the prospective payer to the target vendor over the one year period may be the spend amount from the target vendor history file 58 (FIG. 12) as recorded in spend field 340 (FIG. 10).

Referring briefly to FIG. 14c, in an exemplary embodiment, the payer marketing application 92 may maintain a payer centric spend table 240 (which may be a non transitory data structure embodied in computer readable media) which includes a record 242 associated with each score value 1-5. The record designates criteria for assigning the score value. In the exemplary embodiment: i) a score value of 1 is assigned if the aggregate amount of payments expected to be made by the prospective payer to the target vendor over a one year period is less than or equal to $5,000; ii) a score value of 2 is assigned if the aggregate amount of payments expected to be made by the prospective payer to the target vendor over a one year period is between $5,001 and $10,000; iii) a score value of 3 is assigned if the aggregate amount of payments expected to be made by the prospective payer to the target vendor over a one year period is between $10,001 and $15,000; iv) a score value of 4 is assigned if the aggregate amount of payments expected to be made by the prospective payer to the target vendor over a one year period is between $15,001 and $50,000; and v) a score value of 5 is assigned if the aggregate amount of payments expected to be made by the prospective payer to the target vendor over a one year period is greater than $50,000.

Returning to FIG. 13, step 218 represents determining the target vendor's payer centric frequency score. The target vendor's payer centric frequency score is a function of the quantity of payments expected to be made by the prospective payer over the predetermined period of time from the target vendor history file 58 (FIG. 12) as recorded in the frequency field 342 (FIG. 10) and may be may be an integer value of one (1) through five (5).

Referring briefly to FIG. 14d, in an exemplary embodiment, the payer marketing application 92 may maintain a payer centric frequency table 244 (which may be a non transitory data structure embodied in computer readable media) which includes a record 246 associated with each score value 1-5. The record designates criteria for assigning the score value. In the exemplary embodiment: i) a score value of 1 is assigned if the total quantity of payments expected to be made by the prospective payer to the target vendor over a one year period is no greater than one (1); ii) a score value of 2 is assigned if the total quantity of payments expected to be made by the prospective payer to the target vendor over a one year period is two (2) to three (3); iii) a score value of 3 is assigned if the total quantity of payments expected to be made by the prospective payer to the target vendor over a one year period is between four (4) and ten (10); iv) a score value of 4 is assigned if the total quantity of payments expected to be made by the prospective payer to the target vendor over a one year period is between eleven (11) and fifteen (15); and v) a score value of 5 is assigned if the total quantity of payments expected to be made by the prospective payer to the target vendor over a one year period is greater than fifteen (15).

Returning to FIG. 13, step 220 represents determining the target vendor's network spend score if there is more than one enrolled or prospective payer associated with the target vendor, preferably as recorded in the payer information table 337 (FIG. 10). The target vendor's network spend score is a function of the aggregate value of all payments expected to be made by all such payers over the predetermined period of time and may be may be an integer value of one (1) through five (5).

Referring briefly to FIG. 14e, in an exemplary embodiment, the payer marketing application 92 may maintain a network spend table 248 (which may be a non transitory data structure embodied in computer readable media) which includes a record 250 associated with each score value 1-5. The record designates criteria for assigning the score value. In the exemplary embodiment: i) a score value of 1 is assigned if the aggregate amount of payments expected to be made to the target vendor by multiple payers over a one year period; divided by the number of payers making payment to the target vendor to derive a “per payer average” results in a per payer average less than or equal to $5,000; ii) a score value of 2 is assigned if the aggregate amount of payments expected to be made to the target vendor by multiple payers over the one year period results in a per payer average between $5,001 and $10,000; iii) a score value of 3 is assigned if the aggregate amount of payments expected to be made to the target vendor by multiple payers over a one year period results in a per payer average between $10,001 and $15,000; iv) a score value of 4 is assigned if the aggregate amount of payments expected to be made to the target vendor by multiple payers over a one year period results in a per payer average between $15,001 and $50,000; and v) is assigned if the aggregate amount of payments expected to be made to the target vendor by multiple payers over a one year period results in a per payer average greater than $50,000.

Returning to FIG. 13, step 222 represents determining the target vendor's network centric frequency score if there is more than one enrolled or prospective payer associated with the target vendor, preferably as recorded in the payer information table 337 (FIG. 10). The target vendor's network frequency score is a function of the totally quantity of payments expected to be made by all such payers to the target vendor over the predetermined period and may be may be an integer value of one (1) through five (5).

Referring briefly to FIG. 14f, in an exemplary embodiment, the payer marketing application 92 may maintain a network frequency table 252 (which may be a non transitory data structure embodied in computer readable media) which includes a record 254 associated with each score value 1-5. The record designates criteria for assigning the score value. In the exemplary embodiment: i) a score value of 1 is assigned if the total quantity of payments expected to be made to the target vendor by the multiple payers; divided by the number of payers making payment to the target vendor to result in a “per payer average” results in a per payer average of one (1); ii) a score value of 2 is assigned if the total quantity of payments expected to be made to the target vendor by the multiple payers results in a per payer average of two (2) to three (3); iii) a score value of 3 is assigned if the total quantity of payments expected to be made to the target vendor by the multiple payers results in a per payer average of four (4) and ten (10); iv) a score value of 4 is assigned if the total quantity of payments expected to be made to the target vendor by the multiple payers results in a per payer average of eleven (11) and fifteen (15); and v) a score value of 5 is assigned if the total quantity of payments expected to be made to the target vendor by the multiple payers results in a per payer average of sixteen (16) or greater. In all cases fractional values may be rounded to the nearest integer value, rounded up to the nearest integer value, or rounded down (i.e. truncated) to the nearest integer value.

Returning to FIG. 13, step 224 represents weighting each score. Referring to the weighting table of FIG. 14g, each score, as determined at steps 214 through 222 is multiplied by a weight factor 238 to determine a weighted score.

More particularly, at step 224a, the sensitivity score is weighted (or multiplied by) a factor of 1.0 to determine a weighted industry sensitivity score.

At step 224b the payer centric spend score is weighted by a factor of 0.65 to determine a weighted payer centric spend score. Provided however, in the event the payer centric spend score is greater than four (4) and the payer centric frequency score is less than two (2), the payer centric spend score is weighted by a factor of 0.2 to determine the weighted payer centric spend score.

At step 224c the payer centric frequency score is weighted by a factor of 0.85 to determine a weighted payer centric frequency score.

At step 224d the network spend score is weighted by a factor of 0.75 to determine a weighted network spend score. Provided however, in the event the network spend score is greater than four (4) and the network frequency score is less than two (2), the network spend score is weighted by a factor of 0.2 to determine the weighted network spend score.

At step 224e the network frequency score is weighted by a factor of 0.95 to determine a weighted network frequency score.

Step 226 represents calculating an overall score. The overall score is the average of the weighted industry sensitivity score, the weighted payer centric spend score, the weighted payer centric frequency score, the weighted network spend score, and the weighted network frequency score. It should be appreciated that each weight factor associated with each score may be distinct from other weight factors associated with other scores.

Step 228 represents determining an industry based target transaction rate for the target vendor by mapping the overall score to a rate tier. Referring to FIG. 14h, examples of how the mapping may be performed include: i) rounding the overall score to the closest rate tier score value 258, for example overall score of 2.51 maps to rate Tier_{—}3; and ii) truncating the overall score to the closest rate tier value, for example overall score of 2.51 maps to rate Tier_{—}2.

It should be appreciated that the steps represented by FIG. 13 represent the exemplary embodiment wherein the overall score and the industry based rate assigned to the target vendor are a function of all of the target vendor's industry score, payer centric spend score, payer centric frequency score, network spend score, and network frequency score. The scope of the present invention includes determining the overall score and rate tier assignment as a function of permutations of one or more of any of these scores.

For example, determining the rate tier based on: i) industry score only (permutation of only one score), ii) industry score, payer centric spend score, and payer centric frequency score (permutation of three scores); and iii) industry score, network spend score, and network frequency score (a different permutation of three scores). When permutations of fewer than all scores are used, the weighted average is based on only those scores that are used.

Returning to FIG. 11, the target vendor rebate potential calculated at step 1176d may be based on the enrolled vendor rate determined at step 210 or the industry based rate determined at step 228, as applicable, multiplied by the aggregate value of all payments made to the target vendor by the prospective payer over the period of time, preferably from the target vendor history file 58 (FIG. 12) as recorded in field 340 of the payer information table 337 (FIG. 10).

After the target vendor rebate potential is determined for each target vendor represented in the prospective payer's target vendor history file 58, an aggregate enrolled target vendor rebate potential is calculated at step 1178. More specifically, the enrolled target vendor rebate potential is the aggregate rebate potential, as determined at step 1176d, for each target vendor represented on the prospective payer's vendor history file 58 which is an enrolled target vendor or for which an enrollment based target vendor rebate potential is calculated at step 1176(d) (FIG. 11) using an enrollment based rate determined at step 210 (FIG. 13).

Step 1180 represents determining an aggregate non-enrolled target vendor rebate potential. More specifically, the non-enrolled vendor rebate potential is the aggregate rebate potential as determined at step 1176d, for each target vendor represented on the prospective payer's vendor history file which is a non-enrolled target vendor or for which an industry based target vendor rebate potential is determined at step 1176(d) (FIG. 11) using an industry based rate determined at step 228 (FIG. 13).

Step 1182 represents calculating: i) an enrolled vendor percentage which is the percentage of target vendors represented on the prospective payer's vendor history file which are enrolled target vendors; ii) an enrolled vendor spend value which is the aggregate spend value over a period of time, such as one year, for all target vendors represented on the prospective payer's vendor history file 58 which are enrolled target vendors; iii) an enrolled vendor spend percentage which is the percentage of spend over the period of time which is paid to enrolled target vendors; iv) an enrolled vendor payment quantity which is the total quantity of payments over the period of time to enrolled target vendors; v) an enrolled vendor payment percentage which is the percent of the total quantity of payments made by the prospective payer over the period of time which are made to enrolled target vendors; and vi) a non enrolled vendor payment percentage which is the percent of the total quantity of payments made by the prospective payer over the period of time which are made to non-enrolled target vendors.

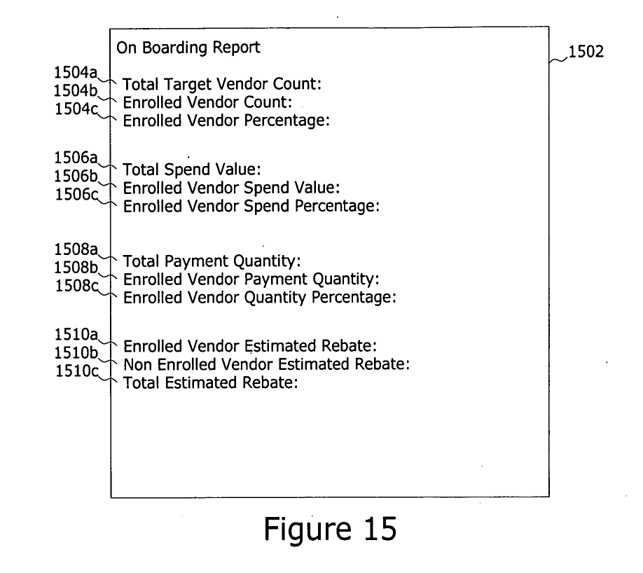

Step 1184 represents generating an onboard report. FIG. 15 represents an exemplary onboard report 1502. The onboard report 1502 is a non transitory data structure stored on the computer readable media 103 (FIG. 1) and is further delivered electronically to a prospective payer, rendered as output as a paper document on a printer or rendered on an electronic display screen.

The exemplary onboard report 1502 includes: i) a total target vendor count 1504a representing the quantity of target vendors in the prospective payer's vendor history file; ii) an enrolled vendor count 1504b representing the quantity of target vendors which are enrolled target vendors; and ii) an enrolled vendor percentage value 1504c representing to the percentage of the total quantity of target vendors which are enrolled target vendors.

The onboard report 1502 further includes: i) a total spend value 1506a representing the aggregate target vendor spend value from the vendor history file; ii) an enrolled vendor spend value 1506b representing the aggregate target spend value for those target vendors which are enrolled target vendors; and iii) an enrolled vendor spend percentage 1506c representing the percentage of total spend value paid to enrolled target vendors.

The onboard report 1502 further includes: i) total payment quantity 1508a representing the aggregate quantity of payments to all target vendors of the period of time; ii) an enrolled vendor payment quantity 1508b representing the aggregate quantity of payments over the period of time to target vendors that are enrolled target vendors; and iii) an enrolled vendor quantity percentage 1508c representing the percentage of the total quantity of payments to all target vendors which are paid to enrolled target vendors.

The onboard report 1502 further includes: i) the initial estimated rebate 1510a; ii) a non-enrolled vendor estimated rebate 1510b; and iii) total estimated rebate 1510c representing the sum of the initial estimated rebate 1510a and the non-enrolled vendor estimated rebate 1510b.

Returning to FIG. 1, the vendor marketing application 94 includes instructions useful for marketing the electronic payments and remittance system 20 to prospective vendors. In general, the vendor marketing application 94 assigns a priority value to each record of the vendor community database (which represents a non-enrolled vendor) to facilitate soliciting prospective vendors to register with the payment system 20 in a priority order.

The priority order may be based on creating subsets of vendors based on at least one of multiple priority values 276 associated with the vendor indicating predetermined and/or configurable criteria making the vendor desirable. Referring to FIG. 14 in conjunction with FIG. 13, examples of such criteria 280 include: i) criteria 280a, the total quantity of payments expected to be made to the vendor using the system 20 as to derived from the value of the aggregate payments field 272; ii) criteria 280b, the total amount of payments expected to be made to the vendor using the system 20 as derived from the aggregates payment value file 174; iii) criteria 280c, the total quantity of payers 22 expected to make payments to the prospective vendor as derived from the quantity of system IDs (each representing a payer) in the payer table 278; iv) criteria 280d, the desirability of the vendor from a strategic perspective by matching to objective external data; and criteria 280e, the desirability of the vendor from a strategic perspective—meaning publicity value of having the vendor registered with the system 20 has intangible or good will value.

As an exemplary implementation, each vendor record may include one or more priority fields 276. Each field 276 may include a priority information value assigning the vendor to a subset (A, B, C) based on one of the above described criteria 280.

More specifically, and with reference to FIG. 15 in conjunction with FIG. 13 and FIG. 15, the segmentation engine 96 may comprise steps for applying such criteria 280 to each prospective vendor represented in the direct marketing database 100.

Step 284 represents reading the criteria (example criteria 280a) and in particular rules 282 applicable to the criteria. For exemplary criteria 280a, the rules 282 may comprise assigning, to the prospective vendor, a priority information value of: i) “A” if total quantity of payments exceeds a first predetermined or configurable threshold such as the value 200; ii) “B” if the total quantity of payments exceeds a second predetermined or configurable threshold such as the value 100; or iii) “C” if the total quantity of payments does not exceed a third predetermined or configurable threshold such as 100. The second and third threshold's may be the same or may be different from each other.

For exemplary criteria 280b, the rules 282 may comprise assigning, to the prospective vendor, a priority information value of: i) “A” if total value of payments exceeds a first predetermined or configurable threshold such as the value $50,000; ii) “B” if the total value of payments exceeds a second predetermined or configurable threshold such as the value $25,000; or iii) “C” if the total value of payments does not exceed a third predetermined or configurable threshold such as $25,000. Again, the second and third threshold's may be the same or may be different from each other.

For exemplary criteria 280c, the rules 282 may comprise assigning, to the prospective vendor, a priority information value of: i) “A” if total quantity of payers exceeds a first predetermined or configurable threshold such as the value 20; ii) “B” if the total quantity of payers exceeds a second predetermined or configurable threshold such as the value 10; or iii) “C” if the total quantity of payers does not exceed a third predetermined or configurable threshold such as 10. Again, the second and third threshold's may be the same or may be different from each other.

For exemplary criteria 280d, the rules 282 may by obtained by both reading the rules and connecting to a remote server providing rule parameters such as a list of the thirty companies making up the Dow Jones Industrial Average and the list of companies making up the S&P 500. Assigning a priority information value by applying the rules to the prospective vendor may comprise assigning, to the prospective vendor, a priority information value of: i) “A” if the prospective vendor is one of the companies making up the Dow Jones Industrial Average; ii) “B” if the prospective vendor is one of the companies making up the S&P 500 but is not part of the Dow Jones Industrial average; or iii) “C” for all prospective vendors which are not part of the S&P 500 or the Dow Jones Industrial Average.

Exemplary criteria 280e may be intangible value applied by user selection by way of work flow discussed herein.

Steps 286 through 290 represent applying the rule to the prospective vendor and writing the priority information value resulting from application of the rule to the record associated with the prospective vendor respectively. The loop back from step 290 to 286 represents application of steps 286 and 290 to each prospective vendor represented in the direct marketing database 100. As such, each prospective vendor represented in the direct marketing data base will be assigned to one or more subsets of vendors based on application of the predetermined and configurable segmentation criteria 280.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. A system for marketing, to a prospective payer, an electronic payment and remittance system which automates payments from each enrolled payer, of a community of payers, to each enrolled vendor, of a community of vendors, the system comprising a computer readable medium, non transitory data structures encoded on the computer readable medium, computer code encoded on the computer readable medium, and a processor executing the computer code, the data structures and computer code comprising:
a vendor history file received from the prospective payer, the vendor history file comprising a group of unique records, each record associating, with a unique target vendor of a group of target vendors to which the prospective payer makes payment, identifying attributes of the target vendor and a target vendor spend value, the target vendor spend value being the amount payable by the prospective payer to the target vendor over a period of time;
a sensitivity score database, the sensitivity score database associating each industry code of a group of industry codes with a sensitivity rating;
an payer marketing comprising instructions coded to the computer readable memory and executed by the processor, the instructions comprising;
for each target vendor of a first group of target vendors, determining an target vendor industry based rebate potential by:
using the identifying attributes to determine an industry code to associate with the target vendor, the industry code being a selected one of the group of industry codes which identifies an industry in which the target vendor participates;
looking up, in the sensitivity score database, the sensitivity rating associated with the industry code associated with the target vendor;
calculating a target transaction fee rate as a function of the sensitivity rating associated with the industry code;
calculating the target vendor industry based rebate potential, the target vendor industry based rebate potential being the product of the target vendor spend value multiplied by the target transaction fee rate;
calculating an industry based rebate potential, the industry based rebate potential being the sum of each target vendor industry based rebate potential calculated for each target vendor of the group of the first group of target vendors; and
generating an onboard report, the onboard report being a non transitory data structure stored on the computer readable medium, the on board report including identification of the prospective payer and, in association with the identification of the prospective payer, the industry based rebate potential.

2. The system of claim 1:
further comprising a vendor community database, the vendor community database comprising a group of unique records, each record associating, with a unique enrolled vendor of the community of vendors, identifying attributes of the enrolled vendor and a first enrolled payer transaction fee rate applied to payments to the enrolled vendor by at least a first enrolled payer;
the instructions of the payer marketing further comprising:
for each target vendor:
determining that the target vendor is an enrolled target vendor if identifying attributes of the target vendor from the record of the vendor history file match identifying attributes of an enrolled vendor from a record of the vendor community database;
determining that the target vendor is a non-enrolled target vendor if identifying attributes of the target vendor from the record of the vendor history file do not match identifying attributes of an enrolled vendor from a record of the vendor community database;
the group of target vendors is a first group of target vendors consisting only of non-enrolled target vendors;
for each target vendor of a second group of target vendors consisting of enrolled target vendors:
determining a target vendor enrollment based rebate potential, the target vendor enrollment based potential being the product of the target vendor spend value multiplied by the a target transaction fee rate, the target transaction fee rate being a function of the first enrolled payer transaction fee rate associated with the target vendor;
calculating an enrolled vendor rebate potential, the enrolled vendor rebate potential being the sum of the target vendor enrollment based rebate potential determined for each enrolled target vendor; and
the onboarding report further comprising identification of the enrolled vendor rebate potential.

3. The system of claim 2, wherein:
for each enrolled vendor of a subset of the community of enrolled vendors that are paid by more one enrolled payer the record of the vendor community database associated with the enrolled vendor further includes:
a first enrolled payer spend value, the first enrolled payer spend value representing the amount payable by the first enrolled payer to the enrolled vendor during the period of time;
a second enrolled payer transaction fee rate applied to payments to the enrolled vendor by at least a second enrolled payer, the second enrolled payer transaction fee rate being different than the first enrolled payer transaction fee rate;
a second enrolled payer spend value, the second enrolled payer spend value representing the amount payable by the second enrolled payer to the enrolled vendor during the period of time;
determining the target transaction fee rate comprises:
selecting the first enrolled payer transaction fee rate as the target transaction fee rate if the amount payable by the prospective payer to the enrolled vendor over the period of time is closer to the first enrolled payer spend value than to the second enrolled payer spend value; and
selecting the second enrolled payer transaction fee rate as the target transaction fee rate if the amount payable by the prospective payer to the enrolled vendor over the period of time is closer to the second enrolled payer spend value than to the first enrolled payer spend value.

4. The system of claim 2, wherein:
the vendor history file further includes, for each target vendor, identification of the quantity of payments made by the prospective payer to the target vendor during the period of time;
for each enrolled vendor of a subset of the community of vendors that are paid by more one enrolled payer the record of the vendor community database associated with the enrolled vendor further includes:
a first enrolled payer spend frequency, the first enrolled payer spend frequency representing the quantity of payments made by the first enrolled payer to the enrolled vendor during the period of time;
a second enrolled payer transaction fee rate applied to payments to the enrolled vendor by at least a second enrolled payer, the second enrolled payer transaction fee rate being different than the first enrolled payer transaction fee rate;
a second enrolled payer spend frequency, the second enrolled payer spend frequency representing the amount payable by the second enrolled payer to the enrolled vendor during the period of time;
determining the target transaction fee rate comprises:
selecting the first enrolled payer transaction fee rate as the target transaction fee rate if the quantity of payments made by the prospective payer to the target vendor during the period of time is closer to the first payer enrolled payer spend frequency than to the second enrolled payer spend frequency; and
selecting the second enrolled payer transaction fee rate as the target transaction fee rate if the quantity of payments made by the prospective payer to the target vendor during the period of time is closer to the second enrolled payer spend frequency than to the first enrolled payer spend frequency.

5. The system of claim 2, wherein:
the vendor history file further includes, for each target vendor, identification of the quantity of payments made by the prospective payer to the enrolled vendor during the period of time;
for each enrolled vendor of a subset of the community of vendors that are paid by more one enrolled payer the record of the vendor community database associated with the enrolled vendor further includes:
a first enrolled payer spend value, the first enrolled payer spend value representing the amount payable by the first enrolled payer to the enrolled vendor during the period of time;
a first enrolled payer spend frequency, the first enrolled payer spend frequency representing the quantity of payments made by the first enrolled payer to the enrolled vendor during the period of time;
a second enrolled payer transaction fee rate applied to payments to the enrolled vendor by at least a second enrolled payer, the second enrolled payer transaction fee rate being different than the first enrolled transaction fee rate;
a second enrolled payer spend value, the second enrolled payer spend value representing the amount payable by the second enrolled payer to the enrolled vendor during the period of time; and
a second enrolled payer spend frequency, the second enrolled payer spend frequency representing the quantity of payments made by the second enrolled payer to the enrolled vendor during the period of time;
determining the target transaction fee rate comprises:
calculating a first enrolled payer spend volume differential value, the first enrolled payer spend volume differential value being a function of the difference between the first enrolled payer spend value and amount payable by the prospective payer to the enrolled vendor over the period of time;
calculating a second enrolled payer spend volume differential value, the second enrolled payer spend volume differential value being a function of the difference between the second enrolled payer spend value and amount payable by the prospective payer to the enrolled vendor over the period of time;
calculating a first enrolled payer spend frequency differential value, the first enrolled payer spend frequency differential value being a function of the difference between the first enrolled payer spend frequency and the quantity of payments made by the prospective payer to the enrolled vendor over the period of time;
calculating a second enrolled payer spend frequency differential value, the second enrolled payer spend frequency differential value being a function of the difference between the second enrolled payer spend frequency and the quantity of payments made by the prospective payer to the enrolled vendor over the period of time;
calculating a first enrolled payer weighted average, the first enrolled payer weighted average being the average of: i) the first enrolled payer spend volume differential value multiplied by a first coefficient; and ii) the first payer spend frequency differential value multiplied by a second coefficient;
calculating a second enrolled payer weighted average, the second enrolled payer weighted average being the average of: i) the second enrolled payer spend volume differential value multiplied by the first coefficient; and ii) the second enrolled payer spend frequency differential value multiplied by the second coefficient;
selecting the first enrolled payer transaction fee rate as the target transaction fee rate if the first enrolled payer weighted average is less than the second so enrolled payer weighted average; and
selecting the second enrolled payer transaction fee rate as the target transaction fee rate if the second enrolled payer weighted average is less than the first enrolled payer weighted average.

6. A system for marketing, to a prospective payer, an electronic payment and remittance system which automates payments from each enrolled payer, of a community of enrolled payers, to each enrolled vendor, of a community of enrolled vendors, the system comprising a computer readable medium, non transitory data structures encoded on the computer readable medium, computer code encoded on the computer readable medium, and a processor executing the computer code, the data structures and computer code comprising:
a vendor community database, the vendor community database comprising a group of unique records, each record associating, with a unique enrolled vendor of the community of enrolled vendors, identifying attributes of the enrolled vendor and a first enrolled payer transaction fee rate applied to payments to the enrolled vendor by at least a first enrolled payer;
a vendor history file received from the prospective payer, the vendor history file comprising a group of unique records, each record associating, with a unique target vendor of a group of target vendors to which the prospective payer makes payment, identifying attributes of the target vendor and a target vendor spend value, the target vendor spend value being the amount payable by the prospective payer to the target vendor over a period of time;
an payer marketing comprising instructions coded to the computer readable memory and executed by the processor, the instructions comprising:
for each target vendor:
determining that the target vendor is an enrolled target vendor if identifying attributes of the target vendor from the record of the vendor history file match identifying attributes of an enrolled vendor from a record of the vendor community database;
for each enrolled target vendor, determining a target vendor enrollment based rebate potential, the target vendor enrollment based rebate potential being the product of the target vendor spend value multiplied by the a target transaction fee rate, the target transaction fee rate being a function of the first enrolled payer transaction fee rate associated with the target vendor;
calculating an enrolled vendor rebate potential, the enrolled vendor potential being the sum of the target vendor enrollment based rebate potential determined for each target vendor that is an enrolled vendor;
generating an onboard report, the onboard report being a non transitory data structure stored on the computer readable medium, the on board report including identification of the prospective payer and, in association with the identification of the prospective payer, the total quantity of target vendors which are enrolled target vendors, and the enrolled vendor rebate potential.

7. The system of claim 6, wherein:
the instructions of the payer marketing further comprise calculating enrolled vendor spend value, enrolled vendor spend value being the sum of the target vendor spend values associated with each target vendor which is determined to be an enrolled vendor; and
the onboard report further includes, in association with identification of the prospective payer, the enrolled vendor spend value.

8. The system of claim 7, wherein the instructions of the payer marketing application further comprise:
determining that the target vendor is a non-enrolled vendor if identifying attributes of the target vendor from the record of the vendor history file do not match identifying attributes of an enrolled vendor from a record of the community database;
for each non-enrolled target vendor, determining a target vendor industry based rebate potential by:
determining an industry sensitivity score for the non-enrolled target vendor, the industry sensitivity score being representative of how sensitive a typical vendor in the same type of business as the non-enrolled vendor is to payment of transaction fees;
using the industry sensitivity score to determine the target transaction fee rate for the non-enrolled vendor;
calculating a target vendor industry based rebate potential, the target vendor industry based rebate potential being the product of the target vendor spend value multiplied by the target transaction fee rate;
calculating a non-enrolled vendor rebate potential, the non-enrolled vendor rebate potential being the sum of the target vendor industry based rebate potential for each target vendor determined to be a non-enrolled vendor;
the onboard report further including at least one of:
the non-enrolled vendor rebate potential; and
total rebate potential, total rebate potential being the sum of enrolled vendor rebate potential and non-enrolled vendor rebate potential.

9. The system of claim 8:
further comprising a sensitivity score database, the sensitivity score database associating each industry code of a group of industry codes with a sensitivity rating; and
determining the industry sensitivity score for each non-enrolled target vendor comprises:
obtaining the non-enrolled target vendor's industry code, the non-enrolled target vendor's industry code being a selected industry code of the group of industry codes;
looking up in the sensitivity score sub database, the sensitivity rating associated with the non-enrolled target vendor's industry code; and
determining the industry sensitivity score for the non-enrolled target vendor to be the sensitivity rating associated with the non-enrolled target vendor's industry code.

10. The system of claim 6, wherein:
for each enrolled vendor of a subset of the community of enrolled vendors that are paid by more one enrolled payer the record of the vendor community database associated with the enrolled vendor further includes:
a first enrolled payer spend value, the first enrolled payer spend value representing the amount payable by the first enrolled payer to the enrolled vendor during the period of time;
a second enrolled payer transaction fee rate applied to payments to the enrolled vendor by at least a second enrolled payer, the second enrolled payer transaction fee rate being different than the first enrolled payer transaction fee rate;
a second enrolled payer spend value, the second enrolled payer spend value representing the amount payable by the second enrolled payer to the enrolled vendor during the period of time; and
determining the target transaction fee rate comprises:
selecting the first enrolled payer transaction fee rate as the target transaction fee rate if the amount payable by the prospective payer to the enrolled vendor over the period of time is closer to the first enrolled payer spend value than to the second enrolled payer spend value; and
selecting the second enrolled payer transaction fee rate as the target transaction fee rate if the amount payable by the prospective payer to the enrolled vendor over the period of time is closer to the second enrolled payer spend value than to the first enrolled payer spend value.

11. The system of claim 10, wherein the instructions of the payer marketing further comprise:
determining that the target vendor is a non-enrolled vendor if identifying attributes of the target vendor from the record of the vendor history file do not match identifying attributes of an enrolled vendor from a record of the community database;
for each non-enrolled target vendor, determining a target vendor industry based rebate potential by:
determining an industry sensitivity score for the non-enrolled target vendor, the industry sensitivity score being representative of how sensitive a typical vendor in the same type of business as the non-enrolled vendor is to payment of transaction fees;
using the industry sensitivity score to determine the target transaction fee rate for the non-enrolled vendor;
calculating a target vendor industry based rebate potential, the target vendor industry based rebate potential being the product of the target vendor spend value multiplied by the target transaction fee rate;
calculating a non-enrolled vendor rebate potential, the non-enrolled vendor rebate potential being the sum of the target vendor industry based rebate potential for each target vendor determined to be a non-enrolled vendor;
the onboard report further including at least one of:
the non-enrolled vendor rebate potential; and
total rebate potential, total rebate potential being the sum of enrolled vendor rebate potential and non-enrolled vendor rebate potential.

12. The system of claim 11:
further comprising a sensitivity score database, the sensitivity score database associating each industry code of a group of industry codes with a sensitivity rating; and
determining the industry sensitivity score for each non-enrolled target vendor comprises:
obtaining the non-enrolled target vendor's industry code, the non-enrolled target vendor's industry code being a selected industry code of the group of industry codes;
looking up in the sensitivity score sub database, the sensitivity rating associated with the non-enrolled target vendor's industry code; and
determining the industry sensitivity score for the non-enrolled target vendor to be the sensitivity rating associated with the non-enrolled target vendor's industry code.

13. The system of claim 6, wherein:
the vendor history file further includes identification of the quantity of payments made by the prospective payer to the enrolled vendor over the period of time;
for each enrolled vendor of a subset of the community of vendors that are paid by more one enrolled payer the record of the vendor community database associated with the enrolled vendor further includes:
a first enrolled payer spend frequency, the first enrolled payer spend frequency representing the quantity of payments made by the first enrolled payer to the enrolled vendor during the period of time;
a second enrolled payer transaction fee rate applied to payments to the enrolled vendor by at least a second enrolled payer, the second enrolled payer transaction fee rate being different than the first enrolled payer transaction fee rate;
a second enrolled payer spend frequency, the second enrolled payer spend frequency representing the quantity of payments made by the second enrolled payer to the enrolled vendor during the period of time; and
determining the target transaction fee rate comprises:
selecting the first enrolled payer transaction fee rate as the target transaction fee rate if the quantity of payments made by the prospective payer to the enrolled vendor over the period of time is closer to the first enrolled payer spend frequency than to the second enrolled payer spend frequency; and
selecting the second transaction fee rate as the target transaction fee rate if the quantity of payments made by the prospective payer to the enrolled vendor over the period of time is closer to the second enrolled payer spend frequency than to the first enrolled payer spend frequency.

14. The system of claim 13, wherein the instructions of the payer marketing further comprise:
determining that the target vendor is a non-enrolled vendor if identifying attributes of the target vendor from the record of the vendor history file do not match identifying attributes of an enrolled vendor from a record of the community database;
for each non-enrolled target vendor, determining a target vendor industry based rebate potential by:
determining an industry sensitivity score for the non-enrolled target vendor, the industry sensitivity score being representative of how sensitive a typical vendor in the same type of business as the non-enrolled vendor is to payment of transaction fees;
using the industry sensitivity score to determine the target transaction fee rate for the non-enrolled vendor;
calculating a target vendor industry based rebate potential, the target vendor industry based rebate potential being the product of the target vendor spend value multiplied by the target transaction fee rate;
calculating a non-enrolled vendor rebate potential, the non-enrolled vendor rebate potential being the sum of the target vendor industry based rebate potential for each target vendor determined to be a non-enrolled vendor;
the onboard report further including at least one of:
the non-enrolled vendor rebate potential; and
total rebate potential, total rebate potential being the sum of enrolled vendor rebate potential and non-enrolled vendor rebate potential.

15. The system of claim 14:
further comprising a sensitivity score database, the sensitivity score database associating each industry code of a group of industry codes with a sensitivity rating; and
determining the industry sensitivity score for each non-enrolled target vendor comprises:
obtaining the non-enrolled target vendor's industry code, the non-enrolled target vendor's industry code being a selected industry code of the group of industry codes;
looking up in the sensitivity score sub database, the sensitivity rating associated with the non-enrolled target vendor's industry code; and
determining the industry sensitivity score for the non-enrolled target vendor to be the sensitivity rating associated with the non-enrolled target vendor's industry code.

16. The system of claim 6, wherein:
the vendor history file further includes identification of the quantity of payments made by the prospective payer to the enrolled vendor over the period of time;
for each enrolled vendor of a subset of the community of vendors that are paid by more one enrolled payer the record of the vendor community database associated with the enrolled vendor further includes:
a first enrolled payer spend value, the first enrolled payer spend value representing the amount payable by the first enrolled payer to the enrolled vendor during the period of time;
a first enrolled payer spend frequency, the first enrolled payer spend frequency representing the quantity of payments made by the first enrolled payer to the enrolled vendor during the period of time;
a second enrolled payer transaction fee rate applied to payments to the enrolled vendor by at least a second enrolled payer, the second enrolled payer transaction fee rate being different than the first enrolled payer transaction fee rate;
a second enrolled payer spend value, the second enrolled payer spend value representing the amount payable by the second enrolled payer to the enrolled vendor during the period of time; and
a second enrolled payer spend frequency, the second enrolled payer spend frequency representing the quantity of payments made by the second enrolled payer to the enrolled vendor during the period of time; and
determining the target transaction fee rate comprises:
calculating a first enrolled payer spend volume differential value, the first payer spend volume differential value being a function of the difference between first enrolled payer spend value and the amount payable by the prospective payer to the enrolled vendor over the period of time;
calculating a second enrolled payer spend volume differential value, the second enrolled payer volume differential value being a function of the difference between the second enrolled payer spend value and the amount payable by the prospective payer to the enrolled vendor over the period of time;
calculating a first enrolled payer spend frequency differential value, the first payer spend frequency differential value being a function of the difference between the difference between the first enrolled payer spend frequency and quantity of payments made by the prospective payer to the enrolled vendor over the period of time;
calculating a second enrolled payer spend frequency differential value, the second enrolled payer spend frequency differential value being a function of the difference between the second enrolled payer spend frequency and the quantity of payments made by the prospective payer to the enrolled vendor over the period of time;
calculating a first enrolled payer weighted average, the first payer weighted average being the average of: i) the first enrolled payer spend volume differential value multiplied by a first coefficient; ii) and the first enrolled payer spend frequency differential value multiplied by a second coefficient;
calculating a second enrolled payer weighted average, the second enrolled payer weighted average being the average of: i) the second enrolled payer spend volume differential value multiplied by the first coefficient; and ii) the second enrolled payer spend frequency differential value multiplied by the second coefficient;
selecting the first enrolled payer transaction fee rate as the target transaction fee rate if the first enrolled payer weighted average is less than the second enrolled payer weighted average; and
selecting the second enrolled payer transaction fee rate as the target transaction fee rate if the second enrolled payer weighted average is less than the first enrolled payer weighted average.

17. The system of claim 16, wherein the instructions of the payer marketing further comprise:
determining that the target vendor is a non-enrolled vendor if identifying attributes of the target vendor from the record of the vendor history file do not match identifying attributes of an enrolled vendor from a record of the community database;
for each non-enrolled target vendor, determining a target vendor industry based rebate potential by:
determining an industry sensitivity score for the non-enrolled target vendor, the industry sensitivity score being representative of how sensitive a typical vendor in the same type of business as the non-enrolled vendor is to payment of transaction fees;
using the industry sensitivity score to determine the target transaction fee rate for the non-enrolled vendor;
calculating a target vendor industry based rebate potential, the target vendor industry based rebate potential being the product of the target vendor spend value multiplied by the target transaction fee rate;
calculating a non-enrolled vendor rebate potential, the non-enrolled vendor rebate potential being the sum of the target vendor industry based rebate potential for each target vendor determined to be a non-enrolled vendor;
the onboard report further including at least one of:
the non-enrolled vendor rebate potential; and
total rebate potential, total rebate potential being the sum of enrolled vendor rebate potential and non-enrolled vendor rebate potential.

18. The system of claim 17:
further comprising a sensitivity score database, the sensitivity score database associating each industry code of a group of industry codes with a sensitivity rating; and
determining the industry sensitivity score for each non-enrolled target vendor comprises:
obtaining the non-enrolled target vendor's industry code, the non-enrolled target vendor's industry code being a selected industry code of the group of industry codes;
looking up in the sensitivity score sub database, the sensitivity rating associated with the non-enrolled target vendor's industry code; and
determining the industry sensitivity score for the non-enrolled target vendor to be the sensitivity rating associated with the non-enrolled target vendor's industry code.
